(19) United States
(12) Patent Application Publication
(10) Pub. No.: US 2025/0263625 A1
(43) Pub. Date: Aug. 21, 2025

(54) LUBRICANT COMPOSITION AND USE THEREOF FOR IMPROVING PRE-IGNITION IN HYDROGEN INTERNAL COMBUSTION ENGINE

(71) Applicants: SAUDI ARABIAN OIL COMPANY, Dhahran (SA); INFINEUM INTERNATIONAL LIMITED, Linden, NJ (US)

(72) Inventors: Modestino De Feo, Saint-Priest (FR); Thomas Featherstone, Bristol (GB)

(73) Assignees: ARAMCO OVERSEAS COMPANY B.V., The hague (NL); INFINEUM INTERNATIONAL LIMITED, Linden, NJ (US)

(21) Appl. No.: 19/055,108

(22) Filed: Feb. 17, 2025

Related U.S. Application Data
(60) Provisional application No. 63/554,693, filed on Feb. 16, 2024.

(51) Int. Cl. C10M 169/04; C10M 101/00; C10M 107/02; C10M 145/14; C10M 177/00; C10N 20/00; C10N 20/02; C10N 30/00; C10N 40/25; C10N 70/00; F02B 43/12; F02M 25/00

(52) U.S. Cl. CPC C10M 169/041; C10M 101/00; C10M 107/02; C10M 145/14; C10M 177/00; F02B 43/12; F02M 25/00; C10M 2203/1006; C10M 2205/0206; C10M 2209/084; C10N 2020/02; C10N 2020/071; C10N 2030/45; C10N 2040/25; C10N 2070/02

(57) ABSTRACT

A method for mitigating preignition events in a hydrogen internal combustion engine. The method includes providing a dosing system in fluid communication with a dosing cylinder of a cylinder block of the hydrogen internal combustion engine; introducing a lubricant including a base oil, a polymer, or mixtures thereof to an intake area of the dosing cylinder via the dosing system; and initiating operating conditions for the hydrogen internal combustion engine.

### CROSS REFERENCE TO RELATED APPLICATIONS

This application claims benefit to U.S. Provisional Application No. 64/544,693 filed on Feb. 16, 2024, the entire contents of which is incorporated herein by reference for all purposes.

### BACKGROUND

Traditional fuel sources, such as gasoline and diesel, are well known contributors of greenhouse gases, which impact the environment. In recent years, legislation requirements are driving the introduction of technologies to replace said fuel sources with “cleaner” and/or renewable options, in an effort to drastically reduce carbon dioxide (CO₂) emissions in the transportation industry.

Alternative fuel sources such as propane, natural gas, electric hybrids, and biodiesel may be viable replacements for gasoline. Feasibility for gasoline replacement depends on many complex factors, including cost, fuel distribution, emissions, vehicle systems analysis, energy storage, power and propulsion systems, and advanced power electronics. Issues with alternative fuel integration include cost, time, and complexity of designing new engine hardware to efficiently process alternative fuels. Electric and hybrid fuel cell vehicles are all significantly more expensive than traditional internal combustion engine vehicles. Accordingly, there exists a need for methods and systems to effectively convert cost-effective, readily available, and environmentally friendly fuel sources to power in the transportation industry.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for mitigating preignition events in a hydrogen internal combustion engine. The method includes providing a dosing system in fluid communication with a dosing cylinder of a cylinder block of the hydrogen internal combustion engine; introducing a lubricant including a base oil, a polymer, or mixtures thereof to an intake area of the dosing cylinder via the dosing system; and initiating operating conditions for the hydrogen internal combustion engine.

In another aspect, embodiments disclosed herein relate to a method for detecting preignition of a lubricant in a hydrogen internal combustion engine. The method includes introducing a lubricant comprising a base oil, a polymer, or mixtures thereof upstream of an ignition timing area of a dosing cylinder of the engine; initiating preignition conditions for the engine; and detecting preignition events in the engine.

In another aspect, embodiments disclosed herein relate to a hydrogen internal combustion engine that includes a dosing system in fluid communication with a dosing cylinder of a cylinder block of the engine. The dosing system includes a dosing lance located downstream of a hydrogen injection area and proximate to an ignition timing area of the dosing cylinder. The dosing system is configured to introduce a lubricant comprising a base oil, a polymer, or mixtures thereof to the dosing cylinder of the cylinder block of the engine.

In another aspect, embodiments disclosed herein relate to a lubricant including base oil and polymer which is derived from a combination of viscosity modifier (e.g., a polymer) and a diluent including less than 50 mass % base oil, and one or more of the following components:
C) one or more detergents;
D) one or more friction modifiers;
E) one or more antioxidants;
F) one or more pour point depressants;
G) one or more anti-foaming agents;
H) one or more viscosity modifiers, in addition to the polymer;
I) one or more dispersants;
J) one or more inhibitors and/or antirust agents; and/or
K) one or more anti-wear agents.

In another aspect, embodiments disclosed herein relate to a lubricant including or resulting from the admixing of:
i) a base oil comprising a Group I base oil, a Group II base oil, a Group III base oil, a Group IV base oil, or combinations thereof;
ii) viscosity modifier, such as acrylate polymers;
iii) detergent (such as a magnesium and or calcium containing detergent (such as detergents comprising magnesium and or calcium salicylate, sulfonate, phenate, or combinations thereof); and/or
iv) at least one zinc dihydrocarbyl dithiophosphate compound.

In another aspect, embodiments disclosed herein relate to a lubricant for use in a hydrogen fueled internal combustion engine. The lubricant includes a base oil (such as low viscosity base oil, such as less than 6 cSt (KV100) viscosity base oil); a viscosity modifier at from 0.1 to 4.0 wt. % of the overall lubricant composition comprising an acrylate copolymer; one or more detergents; and optionally, phosphorus containing anti-wear agent. The lubricant provides at least 20% improvement in pre-ignition events in the hydrogen fueled internal combustion engine compared to the same lubricant absent the viscosity modifier, the low viscosity base oil, or a combination thereof.

In another aspect, embodiments disclosed herein relate to a concentrate including or resulting from the admixing of from 5 wt. % to less than or equal to 30 wt. % of one or more base oils having a KV100 of less than 6 cSt and comprising a Group I base oil, a Group II base oil, a Group III base oil, a Group IV base oil, or combinations thereof; from 5 to 85 wt. %, based upon the weight of the concentrate, of one or more viscosity modifiers comprising an acrylate copolymer; and from 0 to 50 wt. %, based upon the weight of the concentrate, of one or more metal containing detergents.

Other aspects and advantages of the claimed subject matter will be apparent from the following description and the appended claims.

### BRIEF DESCRIPTION OF DRAWINGS

FIG. 1 shows a simplified engine system in accordance with one or more embodiments.

FIG. 2 shows a computer system in accordance with one or more embodiments.

FIG. 3 is a block flow diagram of a method for detecting preignition of a lubricant in a hydrogen internal combustion engine in accordance with one or more embodiments.

FIG. 4 shows a simplified schematic of a test setup at an engine test bench, relevant subsystems, and measuring points for oil dosing tests in accordance with one or more embodiments.

FIG. 5 is a block flow diagram of a method for mitigating pre-ignition events in a hydrogen internal combustion engine in accordance with one or more embodiments.

FIG. 6 is a graph showing the reduction of preignitions (PIs) of lubricants in accordance with one or more embodiments.

FIG. 7 is a graph showing the reduction of PIs of lubricants in accordance with one or more embodiments.

FIG. 8 is a graph showing the reduction of PIs of lubricants in accordance with one or more embodiments

FIG. 9 is a test program of the steady-state one-hour oil dosing test.

FIG. 10 is a graph showing time characteristics of all carbon-containing gaseous components in the intake air and raw exhaust gas as well as the lube oil emission.

FIG. 11 is a result evaluation based on a continuous indicating measurement (51000 single cycles) at the dosing cylinder: Top) Peak pressure and cylinder pressure at spark; Bottom) PI Detection-BIT, mass fraction burned 5% and ignition timing.

FIGS. 12A and 12B are graphs showing crank angle-resolved cylinder pressure traces for regular combustion (Mean) and three oil-induced pre-ignitions with different damage potential (strong, moderate, mild) as well as the position of the ignition timing (IT).

FIG. 13A is a result evaluation classified into the PI damage potential of the number of PIs at the dosing cylinder per 2.5-minute time segment.

FIG. 13B is a result evaluation classified into the PI damage potential of the number of PIs at the dosing cylinder per sub-phase.

FIG. 13C is a result evaluation classified into the PI damage potential of the number of PIs related to the dosing quantity as the final result of the tested lube oil.

FIG. 13D is a result evaluation classified into the PI damage potential of the total number of PIs of all non-dosing cylinders.

FIG. 14 shows the effect of base oil on pre-ignition events obtained on candidate 1 to candidate 4 as compared to the baseline.

FIG. 15 shows the effect of polymer on pre-ignition events obtained on candidate 5 as compared to the baseline.

FIG. 16 shows the total pre-ignition events obtained on all the candidates tested in this study as compared to the base line.

FIG. 17 shows a graph of the strong engine damaging pre-ignition events obtained on all the candidates tested in this study as compared to the base line.

FIG. 18 shows the total pre-ignition events obtained on candidate 5 and Candidate 2 as compared to the base line to assess the repeatability of the test procedure (tests carried out twice). The error bars are given in absolute values.

FIG. 19 shows a graph of the pre-ignition events obtained on the Base line, Candidate 1 to Candidate 5 plotted against the DCN values obtained by means of IQT.

FIG. 20 is a graph showing the reduction in PI events of a PMA-based polymer as compared to a baseline oil.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

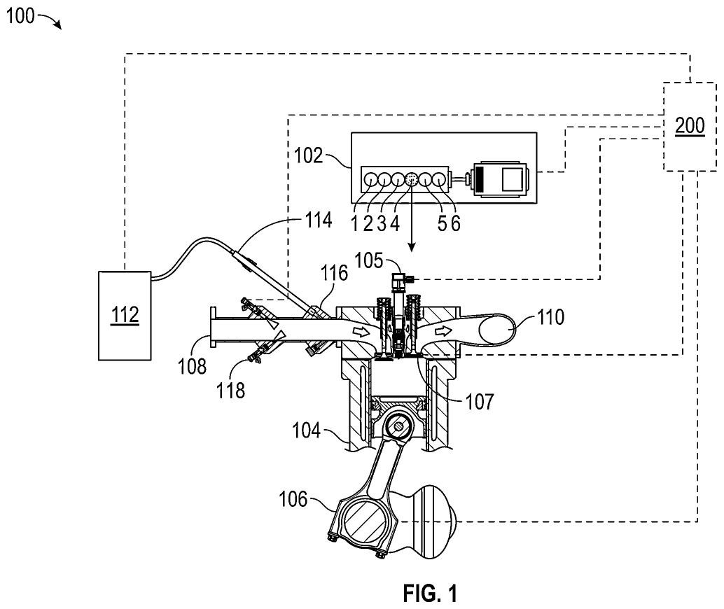

In the following description of FIGS. 1-20, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a polymer” includes reference to one or more polymers.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

The transportation sector is a major fuel consumer in the global energy market. Ensuring an effective response to climate change, propulsion technologies must accelerate significant reduction in CO₂ emissions. As the demand for sustainable transportation options rises, alternatives to traditional fossil fuel vehicles are under investigation. Within the current energy landscape, hydrogen stands out as a promising alternative energy source due to its unique combustion characteristics, such as its high energy content and low environmental impact. This has attracted considerable interest for its potential use in internal combustion engines (ICE) across various sectors.

Hydrogen fuel is considered one of the most cost-effective solutions for a low carbon or carbon-less fuel source which may be used in ICEs, especially for long-haul heavy-duty transportation. The low carbon/carbon-less nature of hydrogen, in combination with the low cost, mature technology and established manufacturing infrastructure for internal combustion engines makes hydrogen a viable alternative to traditional hydrocarbon fuels. Hydrogen, when used as an ICE fuel, undergoes rapid combustion with oxygen, producing water vapor as the primary by-product. The combustion of hydrogen is known for its clean nature because it avoids the production of carbon-based emissions that contribute to climate change.

H₂-ICEs also have the potential to serve as a bridge-technology for original equipment manufacturers (OEMs) to have smooth transition from their existing ICE product portfolio to future technologies such as fuel-cells with a consideration for lesser investment costs and the possibility to use of existing hardware and infrastructure to reduce overall risk. Due to its low volumetric energy density, which requires a technically advanced storage solution, hydrogen may not be the perfect solution for all mobile ICE applications. However, for heavy-duty applications (on-road and off-road), technically and economically realistic solutions are feasible. These solutions can involve storing hydrogen in tanks in gaseous form, or in cryogenic liquid form enabling a range up to 1000 km for a 40-ton truck. Compared to other technologies like batteries, fuel cells, and methanol, the use of hydrogen propulsion in heavy-duty markets is preferred due to its unique capability to address specific challenges related to power, range, weight, refuelling time, and infrastructure. Moreover, it is also characterised by low total cost of ownership (TCO).

The integration of hydrogen as a carbon-free fuel could be a promising strategy for significantly reducing energy-related CO₂ emissions in the road transport sector. Hydrogen, when used as an ICE fuel, undergoes rapid combustion with oxygen, producing water vapor as the primary by-product. However, the unique combustion properties of hydrogen require the development of dedicated lubricants to ensure competitive reliability, power density and efficiency of this alternative technology. Despite the environmental advantages of hydrogen combustion, the deployment of hydrogen internal combustion engines (H₂—ICEs) has some technical challenges. Compared to petrol or natural gas, the minimum ignition energy demand of hydrogen is about 15 times lower, which poses unique challenges for the control of the combustion process in the engine. Additionally, one of the critical issues confronting hydrogen engines, especially in the heavy-duty sector, is the occurrence of pre-ignition (PI) phenomena. PI refers to the spontaneous ignition of the fuel-air mixture before the scheduled spark ignition, leading to uncontrolled combustion and potential engine damage. The low minimum ignition energy of hydrogen leads to the risk of PI events in hydrogen engines leading to uncontrolled combustion and potential engine damage. There are many sources for these unwanted PIs and lubricating oil (or a “lubricant”) can be one of them.

Lubrication plays a fundamental role in the operation of ICEs, regardless of the fuel burned. In conventional engines, lubricants reduce friction, dissipate heat, and contribute to the longevity of engine components.

In the context of H₂-ICE, the role of lubrication becomes even more critical, considering the unique combustion characteristics of hydrogen and the challenges associated with pre-ignition. In H₂-ICE, PI poses unique challenges due to the fuel's fast rapid combustion characteristics and the potential for autoignition under specific conditions. The pre-ignition events can compromise engine efficiency, increase exhaust temperatures, and contribute to the formation of nitrogen oxides (NOx), thereby impacting the engine's environmental footprint. For example, other pollutant emissions such as NOx emissions, traces of lube-oil burn CO₂ and particulates may be present in the exhaust gas. The level of NOx emission mainly depends on the excess air ratio prevalent during combustion. The ability to use very high excess air ratios allows significant reduction in raw NOx emissions but presents challenges for dynamic load response in transient operation and turbocharging.

Lubricating oil is also a possible source of PI, where tiny oil droplets or oil-related deposits in the combustion chamber initiate the ignition process before the desired ignition timing. Oil-based or lubricating oil-based PI sources may originate from a) evaporated oil mists from a cylinder liner; b) oil from the piston ring package; c) oil from the intake manifold coming from a Turbocharger, valve steam seals, and/or a berating system; and c) oil deposits. Non oil-based PI events can be caused by e) ghost sparks (e.g., at the spark plug); f) hot components and hot edges in the combustion chamber; g) poor fuel-air homogeneity; or h) high compression temperature. The nature of hydrogen combustion coupled with the need for lubricants to operate under extreme conditions, requires further studies to develop formulations that can assure the right balance between performance, stability, and environmental considerations.

For oil related PI events, it is expected that the compression temperature will have a large influence as it affects the vaporization process of the oil droplet. This further implies that valve timing strategy, charge air cooling and the amount of residual gas in the cylinder may also be important parameters influencing oil related PIs. Based on the various theoretical sources of PI, it is likely that the sources can interact with each other, leading to an amplification effect and causing the PI events to occur stochastically (i.e., without a clearly attributable source). Therefore, it is difficult to identify a single source for PIs and to estimate its contribution to the total number of PI events in normal engine operation.

Embodiments disclosed herein relate to lubricant compositions and systems including lubricants to mitigate PI events in H₂-ICEs. The use of the lubricant compositions in a H₂-ICE or systems including a H₂-ICE may address the critical problem of PI caused by the lubricant, which contributes to validating safety and efficiency of hydrogen as a sustainable fuel for ICE. One or more embodiments herein may advantageously address the critical problem of preignition events caused by lubricant(s), thereby validating safety and efficiency of hydrogen as a sustainable fuel for ICE. One or more embodiments herein may use an exhaust aftertreatment system (EAS) along with the use of green hydrogen in internal combustion engines to meet the future requirements of zero CO₂ emissions and ultra-low NOx and particulate emissions.

### Lubricant Composition

In one aspect, embodiments herein relate to a lubricating oil composition (or “lubricant,” “LOC,” “lubricant composition,” “lubricating composition,” or “lubricant oil composition”). The lubricant may be designed to reduce PI events in internal combustion engines, such as engines configured for hydrogen internal combustion. The lubricant of one or more embodiments may include a base oil, a polymer, or mixtures thereof.

The polymer may include, but is not limited to, an acrylate polymer. The polymer may include a complex macromolecular structure such as a comb-like structure, brush-like structures, bottlebrush, branched, straight-chain, or combinations thereof. In one or more embodiments, the polymer includes a comb-like polymethyl acrylate (PMA)-based polymer (e.g., Viscoplex® 3-201 available from Evonik).

In some embodiments, the polymer is derived from a combination of a viscosity modifier (e.g., a polymeric viscosity modifier) and a diluent. As used herein, the terms “derivatives” or “derived from” refers to a chemically modified compound or mixture obtained from a starting material (e.g., mineral oil, a polymer, a base oil, PAOs, etc.). The compound or mixture may be obtained after covalent functionalization of the starting material, ionization of the starting material, complexation of the starting material, among other synthetic and/or engineering processes known to those skilled in the art.

The polymer may be or may include a viscosity modifier. In one or more embodiments, the lubricating composition includes a polymer, one or more additional viscosity modifiers, a base oil, and combinations thereof. Viscosity modifiers (also referred to as “viscosity index improvers” or “viscosity improvers” or “polymers”) can be included in the lubricating compositions described herein. Viscosity modifiers provide lubricants with high and low temperature operability. These additives impart shear stability at elevated temperatures and acceptable viscosity at low temperatures. Suitable viscosity modifiers include high molecular weight hydrocarbons, such as polyesters, etc. Typical molecular weights of these polymers are between about 10,000 to 1,500,000 g/mol, more typically about 20,000 to 1,200,000 g/mol, and even more typically between about 50,000 and 1,000,000 g/mol.

Other examples of suitable viscosity modifiers are polymethacrylate (copolymers of various chain length alkyl methacrylates, for example), some formulations of which also serve as pour point depressants. Other suitable viscosity modifiers include copolymers of ethylene and propylene, and polyacrylates (copolymers of various chain length acrylates, for example).

Copolymers useful as viscosity modifiers include those commercially available from Chevron Oronite Company LLC under the trade designation “PARATONE™” (such as “PARATONE™ 8921,” “PARATONE™ 68231,” and “PARATONE™ 8941”); from Afton Chemical Corporation under the trade designation “HiTEC™” (such as HiTEC™ 5850B, and HiTEC™ 5777); and from The Lubrizol Corporation under the trade designation “Lubrizol™ 7067C”.

Polymers useful as viscosity modifiers herein include polymethacrylate or polyacrylate polymers, such as linear polymethacrylate or polyacrylate polymers, such as those available from Evonik Industries under the trade designation “Viscoplex™” (e.g., Viscoplex™ 6-954, Viscoplex™ 3-201) or star polymers which are available from Lubrizol Corporation under the trade designation Asteric™ (e.g., Lubrizol™ 87708 and Lubrizol™ 87725).

Typically, the viscosity modifiers may be used in an amount of about 0.01 to about 15 mass % based upon the total weight of the lubricating oil composition and/or a concentrate, such as about 0.01 to about 10 mass %, about 0.1 to about 7 mass % (mass percent or “weight percent”), such as 0.1 to about 4 mass %, such as about 0.2 to about 2 mass %, such as about 0.2 to about 1 mass %, and such as about 0.2 to about 0.5 mass %, based on the total weight of the formulated lubricant composition. For example, the lubricating composition or the concentrate may include one or more viscosity modifiers in an amount from 0.001 to 10 mass %, from 0.01 to 6 mass %, from 0.01 to 5 mass %, from 0.1 to 4 mass %, from 0.1 to 2 mass %, or from 0.1 to 1 mass % based upon the total weight of the lubricating oil composition and/or the concentrate. The lubricating composition and/or the concentrate may include one or more viscosity modifiers in an amount in a range having a lower limit of any one of 0.0001, 0.0005, 0.001, 0.005, 0.01, 0.045, 0.05, 0.10, 0.15, 0.20, 0.25, 0.50, 0.75, 1.0, 2.0, 3.0, and 4.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, 5.5, 6, 6.5, 7.0, 7.5, 8.0, 8.5, 9.0, 9.5, 9.8, 9.9, 10.0, 11.0, 12.0, 13.0, 14.0, 15.0, and 16.0 mass %, where any lower limit can be paired with any mathematically compatible upper limit.

Viscosity modifiers are typically added as concentrates, in large amounts of diluent oil (e.g., a base oil). The “as delivered” viscosity modifier typically contains from 2.5 mass % to 75 mass % of an active polymer for polymethacrylate or polyacrylate polymers, or from 8 mass % to 20 mass % of an active polymer for olefin copolymers, in the “as delivered” polymer concentrate.

In one or more embodiments, a concentrate includes or is obtained from a base oil, a viscosity modifier that includes an acrylate copolymer, and an optional metal containing detergents. The concentrate may include a viscosity modifier in an amount from 2 to 90 wt % based on the weight of the concentrate. The concentrate may include a viscosity modifier in an amount in a range having a lower limit of any one of 2, 3, 4, 5, 10, 15, 20, 25, 30 35, 40, 45, 50, 55, 60, 65, and 70 wt % and an upper limit of any one of 30, 40, 50, 60, 65, 70, 75, 80, 85, and 90 wt %, where any lower limit can be paired with any mathematically compatible upper limit. The concentrate may include a base oil in an amount from 2 to 95 wt % based on the weight of the concentrate. The concentrate may include a viscosity modifier in an amount in a range having a lower limit of any one of 2, 3, 4, 5, 10, 15, 20, 25, 30 35, 40, 45, 50, 55, 60, 65, and 70 wt % and an upper limit of any one of 30, 40, 50, 60, 65, 70, 75, 80, 85, 90, and 95 wt %, where any lower limit can be paired with any mathematically compatible upper limit.

When lubricating oil compositions contain one or more of the additives, the additive(s) are typically blended into the composition in an amount sufficient for it to perform its intended function. Typical amounts of such additives useful in the present disclosure, especially for use in crankcase lubricants, are shown in Table 1, below.

In one or more embodiments any of the additives may be packaged and shipped from the additive manufacturer as a concentrate, containing one or more additives together, with a certain amount of base oil or other diluents. Accordingly, the weight amounts in the table below, as well as other amounts mentioned herein, are directed to the amount of active ingredient (that is the non-diluent portion of the ingredient). The weight percent (mass %) indicated below is based on the total weight of the lubricating oil composition.

The optional metal containing detergent (such as detergents comprising magnesium and or calcium salicylate, sulfonate, phenate, or combinations thereof) may be included in the concentrate in an amount in a range having a lower limit of any one of 0.1, 0.5, 0.75, 1.0, 2.0, 5.0, 10.0, 15.0, 20.0, 25.0, 30.0, 35.0, and 40.0 wt % and an upper limit of any one of 2.0, 5.0, 10.0, 15.0, 20.0, 25.0, 30.0, 35.0, 40.0, 45.0, 50.0, 55.0, and 60 wt %, where any lower limit can be paired with any mathematically compatible upper limit.

The concentrate may include a base oil in an amount less than 60 mass % based on the total mass of the concentrate, such as less than 50 mass %, 40 mass %, 30 mass %, or 20 mass % base oil and/or one or more optional additives selected from the group consisting of dispersants, detergents (such as detergents comprising magnesium and or calcium salicylate, sulfonate, phenate, or combinations thereof), friction modifiers, antioxidant, pour point depressants, anti-foaming agents, an additional viscosity modifier, an additional polymer, an inhibitor and/or antirust agents, an anti-wear agent, and combinations thereof. In one or more embodiments, the lubricant includes or results from the admixing of a base oil, a viscosity modifier, a detergent, and at least one phosphorous containing anti-wear agent (such as a zinc dihydrocarbyl dithiophosphate (ZDDP) anti-wear compound).

The base oil may be a low viscosity base oil. The phrase “low viscosity base oil” refers to a base oil having a Kinematic Viscosity at 100° C. (KV100) of less than 6 cSt (centistokes), less than 5 cSt, less than 4.5 cSt, or less than 4 cSt. The base oil may include one or more selected from mineral oil, a polyalphaolefin (PAO), one or more mineral oil derivatives, one or more PAO derivatives, and mixtures thereof.

The lubricating composition, the concentrate, or both may include from 1 to 99 mass % of one or more base oils based upon the total weight of the lubricating composition, the concentrate, or both, respectively. For example, the lubricating composition, the concentrate, or both may include one or more base oils from 1 to 99 mass %, from 30 to 95 mass %, from 50 to 90 mass %, from 60 to 95 mass %, or from 70 to 85 mass % based upon the total weight of the lubricating oil composition the concentrate, or both, respectively.

The lubricating composition, the concentrate, or both may include one or more base oils in an amount in a range having a lower limit of any one of 0.5, 1, 5, 10, 15, 20, 25, 30, 35, 40, 45, 50, 55, 60, 65, 70, 75, and 80 mass % and an upper limit of any one of 10, 15, 20, 25, 30, 35, 40, 45, 50, 55, 60, 65, 70, 75, 80, 85, 90, 95, 98, 99, and 99.99 mass %, where any lower limit can be paired with any mathematically compatible upper limit. The base oil of one or more embodiments may have a KV100 of less than 10 cSt, less than 8 cSt, or less than 6 cSt, less than 6 cSt, less than 5 cSt, less than 4.5 cSt, or less than 4 cSt. In some embodiments, the concentrate includes a base oil in an amount greater than 50 wt % based on the total weight of the concentrate. The concentrate may include a base oil in an amount in a range from 5 wt % to less than or equal to 30 wt % based on the total weight of the concentrate.

The various base oils are often categorized as Group I, II, III, IV, or V. Generally speaking, Group I base stocks have a viscosity index of between about 80 to 120 and contain greater than about 0.03% sulfur and/or less than about 90% saturates. Group II base stocks have a viscosity index of between about 80 to 120 and contain less than or equal to about 0.03% sulfur and greater than or equal to about 90% saturates. Group III base stocks have a viscosity index greater than about 120 and contain less than or equal to about 0.03% sulfur and greater than about 90% saturates. Group IV base stocks include polyalphaolefins (PAO). Group V base stocks include base stocks not included in Groups I-IV, such as ester base stocks. (Viscosity index measured by ASTM D 2270, saturates is measured by ASTM D2007, and sulfur is measured by ASTM D5185, D2622, ASTM D42).

The lubricating composition and/or the concentrate in accordance with one or more embodiments may include a base oil that includes one or more selected from the group consisting of a Group I base oil, a Group II base oil, a Group III base oil, a Group IV base oil, and combinations thereof. Group I base oil, a Group II base oil, a Group III base oil, and a Group IV base oil may include properties as defined by the American Petroleum Institute (API). The phrase “Group I base oil” refers to an oil that has a viscosity index in a range having a lower limit of any one of 75, 78, 79, 80, 82, 85, 90, 95, 100, 105, and 110 and an upper limit of any one of 90, 92, 95, 98, 100, 105, 110, 115, 118, 120, and 125, where any lower limit can be paired with any mathematically compatible upper limit. Group I base oils in accordance with one or more embodiments may include 90% saturates or less and/or greater than 0.03% sulfur. Group I base oils may be obtained via solvent-refining processes and have an operating temperature range from about 32 to 150° F.

The phrase “Group II base oil” refers to an oil that has a viscosity index in a range having a lower limit of any one of 75, 78, 79, 80, 82, 85, 90, 95, 100, 105, and 110 and an upper limit of any one of 90, 92, 95, 98, 100, 105, 110, 115, 118, 120, and 125, where any lower limit can be paired with any mathematically compatible upper limit. Group II base oils in accordance with one or more embodiments may include at least 90% saturates or more and 0.03% sulfur or less. Group II base oils may be obtained via a hydrotreating process, such as a hydrocracking refining processes, may have improved antioxidation properties as compared to Group I base oils, may have an improved clarity as compared to Group I base oils, or any combination thereof.

The phrase “Group III base oil” refers to an oil that has a viscosity index in a range having a lower limit of any one of 115 or greater, such as 118 or greater, or 120 or greater. Group III base oils in accordance with one or more embodiments may include at least 90% saturates or more and 0.03% sulfur or less. Group II base oils may be obtained via hydrocracking refining processes using higher pressure and/or heat as compared to hydrocracking used to prepare Group II base oils, may have improved antioxidation properties as compared to Group I and II base oils, may have an improved clarity as compared to Group I and II base oils, or any combination thereof. Group III base oils in accordance with one or more embodiments may have a higher purity as compared to Group I and Group II base oils.

The phrase “Group IV base oil” refers to a PAO that is synthesized. The phrase “Group V base oil” refers all other base oils that are not categorized in Groups I through IV, including but not limited to napthenic oils, silicone, esters (e.g., phosphate ester, polyolester), biolubes, glycols (e.g., polyalkylene glycols), among others. As used herein, the term “polyalphaolefins” or “PAOs” refer to compounds that do not contain cyclic structures, double bonds, or heteroatoms (e.g., sulfur, nitrogen). In one or more embodiments, PAOs do not contain waxy hydrocarbons. In one or more embodiments, the base oil can include one or more selected from the group consisting of one or more polyalphaolefins and mineral oil. The polymer may be a comb-like polymethyl acrylate-based polymer.

Synthetic lubricating oils useful herein as base oils include hydrocarbon oils such as homopolymerized and copolymerized olefins, referred to as polyalphaolefins or PAO's or group IV base oils. Non-limiting examples of PAO's useful as base oils include: poly(ethylenes), copolymers of ethylene and propylene, polybutylenes, polypropylenes, propylene-isobutylene copolymers, chlorinated polybutylenes, poly(1-hexenes), poly(1-octenes), poly(1-decenes), homo- or co-polymers of C₈ to C₂₀ alkenes, homo- or co-polymers of C₈, and/or C₁₀, and/or C₁₂ alkenes, C₈/C₁₀ copolymers, C₈/C₁₀/C₁₂ copolymers, and C₁₀/C₁₂ copolymers, and the derivatives, analogues and homologues thereof.

PAO's useful in the present disclosure typically possess a number average molecular weight of from 100 to 21,000 g/mol in one embodiment, and from 200 to 10,000 g/mol in another embodiment, and from 200 to 7,000 g/mol in yet another embodiment, and from 200 to 2,000 g/mol in yet another embodiment, and from 200 to 500 g/mol in yet another embodiment. Desirable PAO's are commercially available as SpectraSyn™ Hi-Vis, SpectraSyn™ Low-Vis, SpectraSyn™ plus, SpectraSyn™ Elite PAO's (ExxonMobil Chemical Company, Houston Texas) and Durasyn PAO's from Ineos Oligomers USA LLC.

In one or more embodiments, the lubricant, the concentrate, or both include one or more additives. The additives of one or more embodiments may be optional. The lubricant, the concentrate, or both may include one or more additives selected from the group consisting of detergents, modifiers, antioxidants, depressants, anti-foaming agents, viscosity modifiers, dispersants, inhibitors, antirust agents, anti-wear agents, and combinations thereof. In one or more embodiments, the lubricant, the concentrate, or both including a polymer may include one or more selected from dispersants, inhibitors, antirust agents, and/or anti-wear agents.

The lubricating oil compositions and concentrates useful herein comprise components that may or may not remain the same chemically before and after mixing with an oleaginous carrier (such as a base oil) and/or other additives such that the components may be derived from the oleaginous carrier and/or other additives. This disclosure encompasses compositions, which comprise the components before mixing, after mixing, or both, before and after mixing. This disclosure relates to lubricating oil compositions used in the methods described herein comprising or resulting from the admixing of one or more optional components selected from a base oil, a ZDDP compound, a detergent such as a magnesium containing detergent (e.g., magnesium salicylate, overbased magnesium sulfonate, an overbased calcium detergent, an overbased magnesium phenate, or combinations thereof), a friction modifier, an antioxidant, a pour point depressant, an anti-foam agent, a viscosity modifier, a dispersant, an inhibitor and/or antirust agent, an anti-wear agent, a pour point depressant, a seal compatibility agent, an unsaturated C12-C60 hydrocarbons.

The lubricating composition may include a basestock that makes up the balance of the lubricating composition when a polymer, a baseoil, and/or one or more optional additives are included. The term “balance” refers to a basestock in an amount having a lower limit of any one of 45, 50, 55, 60, 65, 70, 75, 80, 85, 90, and 92 mass % and an upper limit of any one of 60, 65, 70, 75, 80, 85, 90, 92, and 95 mass %, where any lower limit can be paired with any mathematically compatible upper limit. In some embodiments, the basestock includes or is a base oil.

The lubricating composition may include from 0.10 to 20 mass % of one or more ZDDP compounds based upon the total weight of the lubricating oil composition. For example, the lubricating composition may include one or more ZDDP compounds in an amount from 0.10 to 20 mass %, from 0.15 to 10 mass %, from 0.20 mass % to 5 mass %, or from 0.25 to 2 mass % based upon the total weight of the lubricating oil composition. The lubricating composition may include one or more ZDDP compounds in an amount in a range having a lower limit of any one of 0.05, 0.10, 0.15, 0.25, 0.50, 0.75, 1.0, 5.0, 10.0, and 15.0 mass % and an upper limit of any one of 1.0, 1.5, 2.0, 2.5, 5.0, 7, 7.5, 8.0, 10, 12, 15, 18, 20, 22, and 25 mass %, where any lower limit can be paired with any mathematically compatible upper limit.

The lubricating composition may include from 0.10 to 20 mass % of one or more detergents (such as a single detergent or a blends of detergents) based upon the total weight of the lubricating oil composition. For example, the lubricating composition may include one or more detergents in an amount from 0.10 to 20 mass %, from 0.15 to 10 mass %, from 0.20 mass % to 5 mass %, or from 0.25 to 2 mass % based upon the total weight of the lubricating oil composition. The lubricating composition may include one or more detergents in an amount in a range having a lower limit of any one of 0.05, 0.10, 0.15, 0.2, 0.25, 0.30, 0.40, 0.50, 0.75, 1.0, 5.0, 10.0, and 15.0 mass % and an upper limit of any one of 1.0, 1.5, 2.0, 2.5, 4.0, 4.5, 5.0, 7, 7.5, 8.0, 9.0, 10, 12, 15, 18, 20, 22, and 25 mass %, where any lower limit can be paired with any mathematically compatible upper limit.

The lubricating composition may include from 0.01 to 20 mass % of one or more dispersants (such as a single dispersant or a blends of dispersants) based upon the total weight of the lubricating oil composition. For example, the lubricating composition may include one or more dispersants in an amount from 0.01 to 20 mass %, from 0.10 to 20 mass %, from 0.1 to 12 mass %, or from 0.1 to 8 mass % based upon the total weight of the lubricating oil composition. The lubricating composition may include one or more dispersants in an amount in a range having a lower limit of any one of 0.005, 0.01, 0.05, 0.10, 0.15, 0.25, 0.50, 0.75, 1.0, 5.0, 10.0, and 15.0 mass % and an upper limit of any one of 1.0, 1.5, 2.0, 2.5, 5.0, 6.0, 7.0, 7.5, 8.0, 10, 12, 15, 18, 20, 22, and 25 mass %, where any lower limit can be paired with any mathematically compatible upper limit.

The lubricating composition may include from 0.01 to 5 mass % of one or more friction modifiers (such as a single friction modifier or a blend of friction modifiers) based upon the total weight of the lubricating oil composition. For example, the lubricating composition may include one or more friction modifiers in an amount from 0.01 to 5 mass %, from 0.1 to 4 mass %, from 0.25 to 3 mass %, or from 0.045-0.15 mass % based upon the total weight of the lubricating oil composition. The lubricating composition may include one or more friction modifiers in an amount in a range having a lower limit of any one of 0.005, 0.01, 0.045, 0.05, 0.10, 0.15, 0.20, 0.25, 0.50, 0.75, 1.0, 2.0, 3.0, and 4.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, and 5.5 mass %, where any lower limit can be paired with any mathematically compatible upper limit.

The lubricating composition may include from 0.01 to 5 mass % of one or more pour point depressants (such as a single pour point depressant or blends of pour point depressants) based upon the total weight of the lubricating oil composition. For example, the lubricating composition may include one or more pour point depressants in an amount from 0.01 to 5 mass %, from 0.01 to 3 mass %, or from 0.1 to 1.5 mass % based upon the total weight of the lubricating oil composition. The lubricating composition may include one or more pour point depressants in an amount in a range having a lower limit of any one of 0.005, 0.01, 0.045, 0.05, 0.10, 0.15, 0.25, 0.50, 0.75, 1.0, 2.0, 3.0, and 4.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, 5.5, 6.0, 7.0, 8.0, and 8.5 mass %, where any lower limit can be paired with any mathematically compatible upper limit.

The lubricating composition may include from 0.01 to 7 mass % of one or more inhibitors (e.g., corrosion inhibitors and/or extreme pressure agents) and/or anti-rust agents (such as a single inhibitor and/or anti-rust agent or blends of inhibitors and/or anti-rust agents) based upon the total weight of the lubricating oil composition. For example, the lubricating composition may include one or more inhibitors and/or anti-rust agents in an amount from 0.01 to 5 mass %, from 0.1 to 3 mass %, or from 0.1 to 1.5 mass % based upon the total weight of the lubricating oil composition. The lubricating composition may include one or more inhibitors and/or anti-rust agents in an amount in a range having a lower limit of any one of 0.005, 0.01, 0.045, 0.05, 0.10, 0.15, 0.25, 0.50, 0.75, 1.0, 2.0, 3.0, and 4.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, 5.5, 6.0, 6.5, 7.0, 7.5, 8.0, 9.0, 10.0, 11.0, and 12.0 mass %, where any lower limit can be paired with any mathematically compatible upper limit.

The lubricating composition may include from 0.01 to 5 mass % of one or more inhibitors and/or anti-rust agents (such as a single inhibitor and/or anti-rust agent or blends of inhibitors and/or anti-rust agents) based upon the total weight of the lubricating oil composition. For example, the lubricating composition may include one or more inhibitors and/or anti-rust agents in an amount from 0.01 to 5 mass %, from 0.1 to 3 mass %, or from 0.1 to 1.5 mass % based upon the total weight of the lubricating oil composition. The lubricating composition may include one or more inhibitors and/or anti-rust agents in an amount in a range having a lower limit of any one of 0.005, 0.01, 0.045, 0.05, 0.10, 0.15, 0.25, 0.50, 0.75, 1.0, 2.0, 3.0, and 4.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, and 5.5 mass %, where any lower limit can be paired with any mathematically compatible upper limit.

The lubricating composition may include from 0.01 to 10 mass % of one or more seal compatibility agents, such as seal swell agents, based upon the total weight of the lubricating oil composition. For example, the lubricating composition may include one or more seal compatibility agents in an amount from 0.01 to 5 mass %, from 0.05 to 2 mass %, or from 0.1 to 1 mass % based upon the total weight of the lubricating oil composition. The lubricating composition may include one or more seal compatibility agents in an amount in a range having a lower limit of any one of 0.005, 0.01, 0.045, 0.05, 0.10, 0.15, 0.25, 0.50, 0.75, 1.0, 2.0, 3.0, and 4.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, 5.5, 7.0, 8.0, 9.0, 10.0, and 12.0 mass %, where any lower limit can be paired with any mathematically compatible upper limit.

The lubricating composition may include from 0.01 to 5 mass % of one or more unsaturated C12-C60 hydrocarbons (such as C12-C24 linear alpha-olefins (LAOs), oligomers/polymers of polyisobutylenes, and/or blends thereof) based upon the total weight of the lubricating oil composition. For example, the lubricating composition may include one or more unsaturated C12-C60 hydrocarbons in an amount from 0.01 to 5 mass %, from 0.1 to 3 mass %, or from 0.1 to 1.5 mass % based upon the total weight of the lubricating oil composition. The lubricating composition may include one or more unsaturated C12-C60 hydrocarbons in an amount in a range having a lower limit of any one of 0.005, 0.01, 0.045, 0.05, 0.10, 0.15, 0.25, 0.50, 0.75, 1.0, 2.0, 3.0, and 4.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, 5.5, 6.0, 6.5, 7.0, 7.5, 8.0, 9.0, 10.0, and 12.0 mass %, where any lower limit can be paired with any mathematically compatible upper limit.

The lubricating composition may include from 0.01 to 10 mass % of one or more antioxidants (such as a single antioxidant or a blend of antioxidants) based upon the total weight of the lubricating oil composition. For example, the lubricating composition may include one or more antioxidants in an amount from 0.01 to 10 mass %, from 0.01 to 5 mass %, from 0.01 to 3 mass %, or from 0.1 to 1.5 mass % based upon the total weight of the lubricating oil composition. The lubricating composition may include one or more antioxidants in an amount in a range having a lower limit of any one of 0.005, 0.01, 0.045, 0.05, 0.10, 0.15, 0.25, 0.50, 0.75, 1.0, 2.0, 3.0, and 4.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, 5.5, 6, 6.5, 7.0, 7.5, 8.0, 8.5, 9.0, 9.5, 9.8, 9.9, 10.0, 11.0, and 12.0 mass %, where any lower limit can be paired with any mathematically compatible upper limit.

The lubricating composition may include from 0.001 to 10 mass % of one or more anti-wear agents (such as a single anti-wear agent or blends of anti-wear agents other than the ZDDP) based upon the total weight of the lubricating oil composition. For example, the lubricating composition may include one or more anti-wear agents in an amount from 0.001 to 10 mass %, from 0.01 to 5 mass %, from 0.1 to 3 mass %, or from 0.1 to 1.5 mass % based upon the total weight of the lubricating oil composition. The lubricating composition may include one or more anti-wear agents in an amount in a range having a lower limit of any one of 0.0001, 0.0005, 0.001, 0.005, 0.01, 0.045, 0.05, 0.10, 0.15, 0.25, 0.50, 0.75, 1.0, 2.0, 3.0, and 4.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, 5.5, 6, 6.5, 7.0, 7.5, 8.0, 8.5, 9.0, 9.5, 9.8, 9.9, 10.0, 11.0, and 12.0 mass %, where any lower limit can be paired with any mathematically compatible upper limit.

The lubricating composition may include from 0.001 to 5 mass % of one or more anti-foaming agents (such as a single anti-foam agent or a blend of anti-foam agents) based upon the total weight of the lubricating oil composition. For example, the lubricating composition may include one or more anti-foam agents in an amount from 0.001 to 5 mass %, from 0.01 to 3 mass %, or from 0.1 to 1.5 mass % based upon the total weight of the lubricating oil composition. The lubricating composition may include one or more anti-foam agents in an amount in a range having a lower limit of any one of 0.0001, 0.0005, 0.001, 0.005, 0.01, 0.045, 0.05, 0.10, 0.15, 0.25, 0.50, 0.75, 1.0, 2.0, 3.0, and 4.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, 5.1, 5.2, and 5.5 mass %, where any lower limit can be paired with any mathematically compatible upper limit.

The foregoing additives are typically commercially available materials. These additives may be added independently, but may be pre-combined in packages, which can be obtained from suppliers of lubricant oil additives. Additive packages with a variety of ingredients, proportions and characteristics are available and selection of the appropriate package will take the use of the ultimate composition into account.

The lubricating composition may include from 0.001 to 20 mass % of one or more acrylamide polymers (including, but not limited to, high molecular weight polyisobutylene succinic anhydride-polyacrylamide, low molecular weight polyisobutylene succinic anhydride-polyacrylamide, among others) based upon the total weight of the lubricating oil composition. The lubricating composition may include one or more acrylamide polymers in an amount in a range having a lower limit of any one of 0.0001, 0.0005, 0.001, 0.005, 0.01, 0.045, 0.05, 0.10, 0.15, 0.25, 0.50, 0.75, 1.0, 2.0, 3.0, 4.0, 5.0, 7.5, 10.0, 12.0, 15.0, and 18.0 mass % and an upper limit of any one of 0.05, 0.10, 0.15, 0.2, 0.25, 0.50, 0.75, 0.80, 1.0, 1.5, 2.0, 2.5, 3.0, 3.5, 4.0, 4.5, 4.8, 5.0, 5.1, 5.2, 5.5, 6.0, 6.5, 7.0, 8.0, 9.0, 10.0, 11.0, 12.0, 15.0, 20.0, and 25.0 mass %, where any lower limit can be paired with any mathematically compatible upper limit.

The lubricant of one or more embodiments includes a total sulfated ash content of less than or equal to 5.0 wt. % (weight percent), such as from 0 to 5 wt. %. In one or more embodiments, the lubricant includes a total sulfated ash content in a range having a lower limit of any one of 0.0 wt. %, 0.01, 0.05, 0.1, 0.2, 0.25, 0.3, 0.5, 0.75, 1.0, and 1.5 wt. % and an upper limit of any one of 0.05 wt. %, 0.1, 0.2, 0.25, 0.3, 0.5, 0.75, 1.0, 1.5, 1.9, 2.0, 2.1, 2.2, 2.5, 2.9, 3.0, 3.2, 3.5, 4.0, 4.5, and 5.0 wt. %, where any lower limit can be paired with any mathematically compatible upper limit. In one or more embodiments, the lubricant includes a Society of Automotive Engineers (SAE) viscosity grade of 25W-X, 20W-X, 15W-X, 10W-X, 5W-X or 0W-X, where X represents any one of 8, 12, 16, 20, 30, 40, 50 or 60. Table 1 provides typical amounts of lubricating oil components in accordance with one or more embodiments. Columns A, B and C each represent a different formulation.

TABLE 1

| Additive Formulations | A (mass % a.i.) | B (mass % a.i.) | C (mass % a.i.) |
|---|---|---|---|
| Dispersant | 0.1-20 | 0.5-10 | 1-6 |
| Detergents | 0.1-20 | 0.2-10 | 0.3-9 |
| Corrosion Inhibitor | 0-7 | 0.05-5 | 0.1-1.5 |
| Anti-rust/extreme | | | |
| pressure agents | | | |
| Overbased Ca detergent | 0.1-10 | 0.2-5 | 0.3-4.5 |
| Overbased Mg detergent | 0.1-10 | 0.2-5 | 0.4-4.5 |
| High MW PIBSA-PAM | 0-20 | 0-8 | 0 to 4 |
| (Polyisobutylene succinic | | | |
| anhydride-Polyacrylamide) | | | |
| Low MW PIBSA-PAM | 0.1-20 | 0.2-10 | 0.5-6 |
| Antioxidant | 0.01-10 | 0.1-5 | 0.1-4 |
| Pour Point Depressant | 0-8 | 0-5 | 0.01-1.5 |
| Anti-foaming Agent | 0-5 | 0-2 | 0.001-0.15 |
| Functionalized Polymer _{—} | 0.01-10 | 0.1-5 | 0.1-2 |
| Friction Modifier | 0-2 | 0.1-1 | 0.2-0.5 |
| Antiwear Agent | 0.01-10 | 0.1-5 | 0.1-3 |
| Viscosity Modifier | 0.1-15 | 0.1-10 | 0.25-3 |
| Seal Swell Agents | 0-10 | 0-5 | 0-2 |
| Extreme Pressure Agents | 0-10 | 0-5 | 0-3 |
| Unsaturated Hydrocarbons | 0-10 | 0-5 | 0-3 |
| (LAOs) | | | |
| Basestock | Balance (such as 50 | Balance | Balance |
| | to 95%) | | |

### H₂-Ice Engine System

In another aspect, embodiments herein relate to an engine system configured for H₂ internal combustion (or “H₂-ICE”). An engine system configured for H₂ internal combustion in accordance with one or more embodiments may include a cylinder block and a dosing system. The engine system in accordance with one or more embodiments may include one or more components known to support H₂ internal combustion. Those components may include, but are not limited to, a plurality of temperature sensors, a plurality of pressure sensors, an air intake section, back pressure regulators, valves, pumps, emission sensors (e.g., NOx sensors, carbon monoxide and/or carbon dioxide sensors, hydrocarbon sensors), a crankshaft, pistons, counterweights, flywheels, a starter, a throttle, gaskets, a charge air temperature conditioning unit, among other components.

The cylinder block may include a plurality of cylinders (e.g., six cylinders). In one or more embodiments, an intake manifold is in fluid communication with the one more cylinders. In one or more embodiments, air is fed to an intake manifold of the engine. Air may be fed through an air inlet in fluid communication with the cylinder bank of the engine. The cylinder bank may include one or more cylinders. For example, one of ordinary skill in the art would recognize that any number of cylinders may be used, such as 1, 2, 3, 4, 5, 6, 8, 10, or 12, each arranged in an in-line, V-, or H-pattern.

As one of ordinary skill may appreciate, each cylinder may include an ignition timing area or an ignition timing component comprising an ignition source. The ignition source may include at least one spark plug such that each of the one or more cylinders independently includes an ignition source. A fuel stream may be introduced to a cylinder via at least one fuel injector upstream of the one or more cylinders of the cylinder bank of the engine. The fuel stream may include a stream of hydrogen (H₂). The fuel stream may be electrochemically produced on-board a vehicle, and may include a compressed H₂ source, among other possible sources of H₂.

The cylinder block of the engine may include at least one dosing cylinder in fluid communication with a dosing lance of the dosing system. In one or more embodiments, each cylinder of the cylinder block is a dosing cylinder. The dosing cylinder may be at least one cylinder included in the one or more cylinders of the cylinder block. In one or more embodiments, the at least one dosing cylinder is in fluid communication with an exhaust line which is in fluid communication with the engine via an open crankcase ventilation line.

The dosing system may be configured to deliver a lubricant composition in accordance with one or more embodiments herein to the dosing cylinder. The lubricant composition may be delivered to the dosing cylinder in the form of an aerosol. In one or more embodiments, the dosing system includes a dosing lance located upstream of an ignition timing area of the intake area. The dosing lance may be located upstream of an ignition timing unit of the dosing cylinder. The dosing lance may be located downstream of a fuel injection area of the cylinder block. In one or more embodiments, the dosing lance is located downstream of hydrogen injection valves that are proximate to the dosing cylinder.

In some embodiments, the dosing cylinder includes a pressure sensor for monitoring pressure changes in the cylinder, PI events, or both. The dosing cylinder may include a sensor configured to monitor PI events within the cylinder. In some embodiments, each cylinder of the cylinder block includes a sensor configured to monitor PI events. The sensor may be capable of measuring occurrence and/or frequency of PI events, for example, via monitoring temperature, pressure, or both in the cylinder. In one or more embodiments, each cylinder of the cylinder block includes a pressure sensor to detect abnormal combustion. The sensor disposed in the dosing cylinder may be configured to obtain data including, but not limited to, continuous temperature measurements, pressure measurements, or both.

A non-limiting example of an engine system 100 in accordance with one or more embodiments may be as shown in FIG. 1. The engine 102 shown in FIG. 1 may be an Anstalt fir Verbrennungskraftmaschinen List (or “AVL”) H₂ engine. In FIG. 1, the engine 102 includes a cylinder block having 6 cylinders. In the cylinder block of engine 102, the fourth cylinder is designated as a dosing cylinder 104. However, as described previously herein, a plurality of the cylinders of the cylinder block or each of the cylinders of the cylinder block may be a dosing cylinder. One or more cylinders of the cylinder block is coupled to a crankshaft 106. Dosing cylinder 104 includes an ignition timing component 105 and a pressure sensor 107 located opposite of crankshaft 106.

Dosing cylinder 104 is in fluid communication with an intake line 108. Intake line 108 may be configured to deliver air, a fuel stream, a lubricant composition, or combinations thereof to dosing cylinder 104. Dosing cylinder 104 is in fluid communication with an exhaust treatment line 110. As shown in FIG. 1, dosing cylinder 104 is in fluid communication with a lubricant source 112 via lubricant injection line 114 and dosing lance 116. Dosing lance 116 is downstream of fuel injectors 118. Lubricant source 112 may be configured to deliver a lubricant to dosing cylinder 104 via line 114 and dosing lance 116.

In some embodiments, a H₂—ICE system is in electrical connection with an automation system, an indicating system, or both (e.g., via the sensor of the dosing cylinder, the sensors of the additional cylinders, one or more additional sensors, or combinations thereof). As shown in FIG. 1, the automation system, indicating system, or both may be in electrical connection with one or more components of an engine, dosing cylinder, engine system, or any combination thereof. For example, the automation system may be in electrical connection with an ignition source (not shown) of an ignition timing component (e.g., component 105) of a dosing cylinder (e.g., cylinder 104). The automation system may be in electrical connection with a pressure sensor (e.g., sensor 107). In one or more embodiments, the automation system is in electrical connection with a pressure sensor (e.g., sensor 107) of one or more cylinders and a charge amplifier (not shown in FIG. 1). In one or more embodiments, the crankshaft (e.g., crankshaft 106) is coupled to an automation system via an angle encoder (not shown).

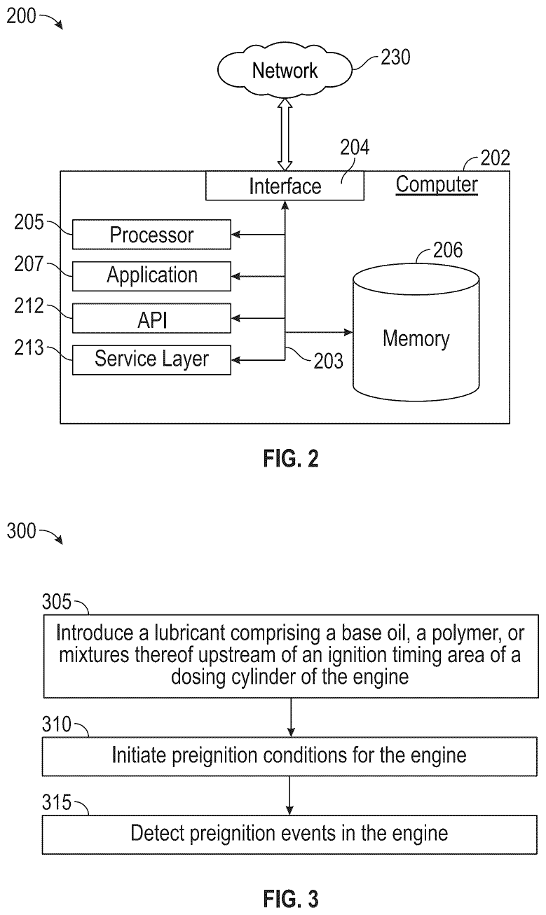

The automation system may be in electrical connection with the indicating system. The automation system and the indicating system may include a first computer and a second computer, respectively (e.g., computer system 200 as shown in FIG. 2). In some embodiments, the automation system and the indicating system are components of the same computing system such that the first computer and the second computer are the same.

In one or more embodiments, the automation system is configured to record data from a sensor of the dosing cylinder of the hydrogen internal combustion engine at a rate of at least 5 Hertz (Hz), at least 10 Hz, at least 15 Hz, or at least 20 Hz. The indicating system may be configured to continuously record data from a sensor located in each dosing cylinder for each cycle of the engine. In some embodiments, the automation system is configured to determine, by the first computer, the second computer, or both, lubricant emission over time by calculating oil dosing quantity, which may be validated with gravimetric measurements of a lubricant source of the dosing system. In some embodiments, the data collected by the second computer includes continuous pressure measurements from each dosing cylinder in the engine block. The second computer may be configured to postprocess the collected data as described. Postprocessing the collected data may include performing method validation and statistical evaluation; and calculating lubricant dosing quantity based on a carbon balance of the engine.

FIG. 2 depicts a block diagram of a computer system (202) used to provide computational functionalities associated with algorithms, methods, functions, processes, flows, and procedures as described in this disclosure, according to one or more embodiments. The illustrated computer (202) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (202) may include a computer that includes an input device, such as a keypad, keyboard, touch screen, or other device that can accept user information, and an output device that conveys information associated with the operation of the computer (202), including digital data, visual, or audio information (or a combination of information), or a GUI.

The computer (202) can serve in a role as a client, network component, a server, a database or other persistency, or any other component (or a combination of roles) of a computer system for performing the subject matter described in the instant disclosure. The illustrated computer (202) is communicably coupled with a network (230). In some implementations, one or more components of the computer (202) may be configured to operate within environments, including cloud-computing-based, local, global, or other environment (or a combination of environments).

At a high level, the computer (202) is an electronic computing device operable to receive, transmit, process, store, or manage data and information associated with the described subject matter. According to some implementations, the computer (202) may also include or be communicably coupled with an application server, e-mail server, web server, caching server, streaming data server, business intelligence (BI) server, or other server (or a combination of servers).

The computer (202) can receive requests over network (230) from a client application (for example, executing on another computer (202) and responding to the received requests by processing the said requests in an appropriate software application. In addition, requests may also be sent to the computer (202) from internal users (for example, from a command console or by other appropriate access method), external or third-parties, other automated applications, as well as any other appropriate entities, individuals, systems, or computers.

Each of the components of the computer (202) can communicate using a system bus (203). In some implementations, any or all of the components of the computer (202), both hardware or software (or a combination of hardware and software), may interface with each other or the interface (204) (or a combination of both) over the system bus (203) using an application programming interface (API) (212) or a service layer (213) (or a combination of the API (212) and service layer (213). The API (212) may include specifications for routines, data structures, and object classes. The API (212) may be either computer-language independent or dependent and refer to a complete interface, a single function, or even a set of APIs. The service layer (213) provides software services to the computer (202) or other components (whether or not illustrated) that are communicably coupled to the computer (202). The functionality of the computer (202) may be accessible for all service consumers using this service layer. Software services, such as those provided by the service layer (213), provide reusable, defined business functionalities through a defined interface. For example, the interface may be software written in JAVA, C++, or other suitable language providing data in extensible markup language (XML) format or another suitable format. While illustrated as an integrated component of the computer (202), alternative implementations may illustrate the API (212) or the service layer (213) as stand-alone components in relation to other components of the computer (202) or other components (whether or not illustrated) that are communicably coupled to the computer (202). Moreover, any or all parts of the API (212) or the service layer (213) may be implemented as child or sub-modules of another software module, enterprise application, or hardware module without departing from the scope of this disclosure.

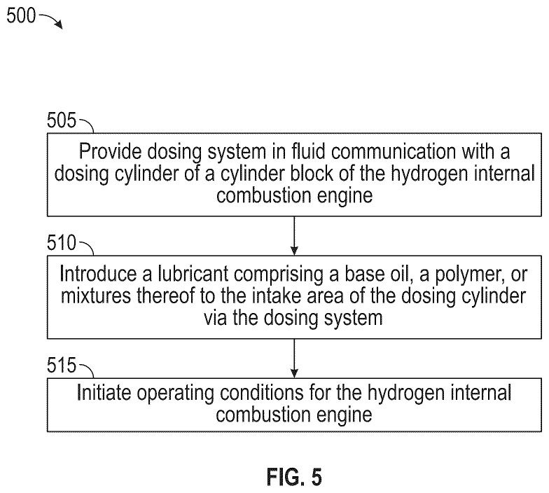

The computer (202) includes an interface (204). Although illustrated as a single interface (204) in FIG. 5, two or more interfaces (204) may be used according to particular needs, desires, or particular implementations of the computer (202). The interface (204) is used by the computer (202) for communicating with other systems in a distributed environment that are connected to the network (230). Generally, the interface (204) includes logic encoded in software or hardware (or a combination of software and hardware) and operable to communicate with the network (230). More specifically, the interface (204) may include software supporting one or more communication protocols associated with communications such that the network (230) or interface's hardware is operable to communicate physical signals within and outside of the illustrated computer (202).

The computer (202) includes at least one computer system (205). Although illustrated as a single computer system (205) in the Figure, two or more processors may be used according to particular needs, desires, or particular implementations of the computer (202). Generally, the computer system (205) executes instructions and manipulates data to perform the operations of the computer (202) and any algorithms, methods, functions, processes, flows, and procedures as described in the instant disclosure.

The computer (202) also includes a memory (206) that holds data for the computer (202) or other components (or a combination of both) that can be connected to the network (230). For example, memory (206) can be a database storing data consistent with this disclosure. Although illustrated as a single memory (206) in the Figure, two or more memories may be used according to particular needs, desires, or particular implementations of the computer (202) and the described functionality. While memory (206) is illustrated as an integral component of the computer (202), in alternative implementations, memory (206) can be external to the computer (202).

The application (207) is an algorithmic software engine providing functionality according to particular needs, desires, or particular implementations of the computer (202), particularly with respect to functionality described in this disclosure. For example, application (207) can serve as one or more components, modules, applications, etc. Further, although illustrated as a single application (207), the application (207) may be implemented as multiple applications (207) on the computer (202). In addition, although illustrated as integral to the computer (202), in alternative implementations, the application (207) can be external to the computer (202).

There may be any number of computers (202) associated with, or external to, a computer system containing computer (202), wherein each computer (202) communicates over network (230). Further, the term “client,” “user,” and other appropriate terminology may be used interchangeably as appropriate without departing from the scope of this disclosure. Moreover, this disclosure contemplates that many users may use one computer (202), or that one user may use multiple computers (202).

### Method for Detecting Preignition Events

In another aspect, embodiments disclosed herein relate to methods for detecting PI events, such as PI events due to a lubricant. The method may be as shown in FIG. 3. In FIG. 3, the method 300 for detecting PI events includes introducing a lubricant including a base oil and a polymer upstream of an ignition timing area (e.g., proximate to an intake area) of a dosing cylinder of the engine as shown in block 305, initiating preignition conditions for the engine as shown in block 310, and detecting preignition events in the engine as shown in block 315. In one or more embodiments, the lubricant is delivered upstream of the dosing cylinder, such as to an intake line in fluid communication with the dosing cylinder.

The method for detecting PI events due to PI of a lubricant may include preparing a lubricant composition as described in one or more embodiments herein. The amount of lubricant provided via the dosing system to the one or more cylinders may be measured via gravimetric determination, such as weighing a storage unit before and after introducing the lubricant composition to the dosing cylinder.

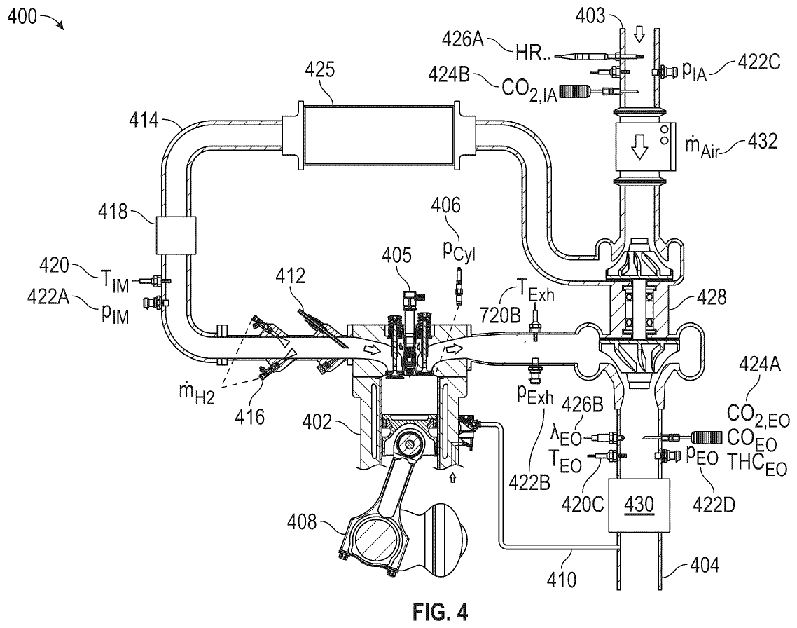

The method may include injecting the lubricant to an engine via an external oil dosing unit of a dosing system via a dosing lance. The method may include injecting a fuel stream upstream of the lubricant dosing lance. The method may be conducted in a test system as shown in FIG. 4 to detect and evaluate PI events for a lubricant composition. FIG. 4 shows a simplified schematic layout of a nonlimiting example of an engine and measuring points that may be used in a method for detecting PI events and in accordance with one or more embodiments.

In engine system 400, a horizontal cross-sectional view of a cylinder 402 (e.g., a dosing cylinder) of a cylinder block of the engine is shown. While a cross-sectional view of one cylinder 402 is shown, it may be appreciated that engine system 400 may include at least one other cylinder of the cylinder block that is in fluid communication with an intake line 403 and an exhaust line 404, includes a timing area and is coupled to a crankcase unit, pressure sensors, or any combinations thereof. Cylinder 402 includes an ignition timing unit 405. Cylinder 402 may be coupled to a crankcase unit 408. The crankcase unit 408 is in fluid communication with exhaust line 404 via a crankcase ventilation line 410 A pressure sensor 406 is located proximate to the ignition timing unit 405 of cylinder 402.

In FIG. 4, the engine includes fuel injection system 416, valve 418, a plurality of temperature sensors (e.g., sensors 420A-420C), a plurality of pressure sensors (422A-422B), carbon oxide and emission component sensors (424A-424B), cooling unit 425, humidity sensor 426A, air ratio sensor 426B, and turbocharger 428, and back pressure regulator 430. Fuel injection system 416 and valve 418 is located on intake line 414 upstream of cylinder 402. Fuel injection system 416 is upstream of dosing lance 412. The mass flow of a hydrogen fuel may be obtained or measured by fuel injection system 416. The plurality of temperature sensors, the plurality of pressure sensors, or both may be located at various positions on the intake line 414 upstream of turbocharger 428, downstream of turbocharger 428, downstream of cylinder 402 on exhaust line 404, downstream of turbocharger 428 on the exhaust line 404, or any combination thereof. In some embodiments, carbon oxide and emission component sensors are located upstream of the turbocharger on intake line 403 and between turbocharger 428 and the back pressure regulator 430. The mass flow of air may be measured by a mass flow unit 432.

In the cylinder 402 of FIG. 4, the position of the dosing lance 412 can be used for the lubricant oil injection (\dot{m}_{Oil}), is located downstream of the H₂ injection valves of injection system 416, and near the inlet of the intake ports of cylinder 402. The lubricant oil may be externally provided. In some embodiments, the lubricant oil is included in a lubricant oil storage unit within engine system 400. The radial, centre-positioned outlet of the lance may be chosen to minimise the risk of wall wetting. Each cylinder may be equipped with a pressure sensor 406 and a crank angle-resolved measurement of the ignition and injection signal to detect abnormal combustion. The engine boundary conditions, such as the charge air and cooling water temperature, as well as the exhaust back pressure may have a considerable influence on the occurrence of lubricating oil-induced PIs, therefore the regulation of these boundary conditions via external conditioning systems and an exhaust back pressure flap may be included. In one or more embodiments, the blow-by gases may not be returned to the cylinders, but instead fed directly into the exhaust via an open crankcase ventilation line (e.g., line 410). Possible influences of non-separated engine oil in the blow-by clean gas can thus be ruled out in advance.

The method may include monitoring temperature changes, pressure changes, emission changes, or combinations thereof with an automation system, an indicating system, or both. The method may include collecting, by a first computer, data from a sensor (e.g., a pressure sensor, a temperature sensor, or both) of an oil dosing cylinder of a cylinder block of the hydrogen internal combustion engine. The method may include collecting, by a second computer, continuous measurements from a sensor located in each cylinder for each cycle of the engine. The second computer and the first computer may be the same or different. The method may include collecting, by a first or second computer, a plurality of data from a plurality of sensors located in the engine.

The method may include postprocessing the collected data and measurements to detect the PI events. In some embodiments, the data collected by the first computer and/or the second computer is processed to calculate an oil dosing quantity (or a “lubricant dosing quantity”). The data collected by the first and/or second computer may include continuous pressure measurements from each cylinder in the engine block. The postprocessing may include performing method validation and statistical evaluation. The postprocessing may include calculating an oil dosing quantity based on a carbon balance of the engine. An example of a carbon balance equation is as shown in Equation (1) below.

$${\dot{m}}_{Oil \_ Emission} = \frac{( {\dot{m}}_{Air} + {\dot{m}}_{H 2} ) \cdot {M}_{C} / {M}_{EO , w} \cdot {v}_{{C}_{EO , w}} - {\dot{m}}_{Air} \cdot {M}_{C} / {M}_{IA , w} \cdot {v}_{CO {2}_{IA , w}}}{{μ}_{{C}_{Oil}} - {M}_{C} / {M}_{EO , w} \cdot {v}_{{C}_{EO , w}}} \qquad ( 1 )$$

$$with {v}_{{C}_{EO , w}} = {v}_{CO {2}_{EO , w}} + {v}_{{CO}_{EO , w}} + {v}_{{HC}_{EO , w}} and {μ}_{{C}_{Oil}} \approx 0.85$$

In Equation (1), the mass flow of fresh air (\dot{m}_{Air}) and hydrogen (\dot{m}_{H2}), the volume fraction of carbon dioxide (ν_{CO2}) in the fresh air (IA) and the exhaust gas (EO), the volume fractions of carbon monoxide (ν_{CO}) and hydrocarbon (ν_{HC}) in the exhaust gas, the carbon content (μ_{C}) in the lube oil as well as the molar mass (M) of the fresh air, exhaust gas and carbon (C) are taken in to account.

In methods which include phases with active oil dosing, the total lube oil related emission is composed of the regular engine lube oil consumption (LOC) born emissions and the additional emissions from the oil dosing quantity. The introduced lubricant oil quantity can be derived from the total lube oil related emission. For example, all carbon-containing gaseous components (CO₂, CO, HC) in the intake air (IA) and in the exhaust gas (EO) may continuously be recorded by the automation system and/or the indicating system. The measurement of the incoming mass flows (air and H₂), the humidity of the intake air (HR_{IA}), the air ratio (λ_{EO}) and the temperatures and pressures in the individual sub-areas (IA, IM, Exh, EO) may be used for monitoring and subsequent plausibility checks as well as input parameters for the carbon balance.

### Method for Mitigating Preignition Events

In another aspect, one or more embodiments herein relate to a method for mitigating PI events in a hydrogen internal combustion engine. The method of mitigating PI events may include one or more steps of a method of detecting PI events as described previously. The method of one or more embodiments may be a method 500 as shown in FIG. 5. In block 505 of method 500 a dosing system in fluid communication with a dosing cylinder of a cylinder block of the hydrogen internal combustion engine system is provided. In block 510, a lubricant including a base oil, a polymer, or mixtures thereof are provided to an intake area of the dosing cylinder via the dosing system. The method 500 includes initiating operating conditions for the H₂-ICE as shown in block 515.

The H₂-ICE system used in a method herein may be as described previously. The method may include providing a lubricant to the H₂-ICE system. The lubricant may be as described previously herein. A lubricant may include a base oil, a polymer, or mixtures thereof to the intake area of the dosing cylinder via the dosing system may be introduced. Operating conditions for the hydrogen internal combustion engine may be initiated.

The lubricant may be delivered to one or more cylinders of the cylinder block. The lubricant may be introduced to a cylinder of the cylinder block via a dosing lance of the dosing system. The cylinder may be a dosing cylinder as described previously. In some embodiments, at least two cylinders of the cylinder block are dosing cylinders. The dosing system may include a lubricant storage unit that is in fluid communication with the dosing lance.

A method of one or more embodiments may include introducing the lubricant directly to at least one cylinder of the cylinder block, upstream of the cylinder, or combinations thereof. In one or more embodiments, the dosing lance is in fluid communication with an intake line of the engine system. The lubricant may be delivered to an intake line of the engine system and at a position that is upstream of a cylinder. The dosing system may deliver the lubricant to the cylinder in the form of a liquid, an aerosol, or combinations thereof.

A method of one or more embodiments may include introducing the fuel stream directly to at least one cylinder of the cylinder block, upstream of the cylinder, or combinations thereof. The lubricant may be delivered to an intake line downstream of a fuel stream. The fuel stream may be introduced at a location on the intake line upstream of the cylinder and the dosing lance. The method may include delivering hydrogen from a hydrogen source to the intake line. In some embodiments, the method includes producing a hydrogen fuel on-board a vehicle, storing a source of hydrogen (e.g., a hydrogen tank) on-board.

In one or more embodiments, an amount of lubricant to provide to the dosing cylinder can be determined prior to introduction to the cylinder. The amount of lubricant may be determined based on measurements obtained from a sensor within the H₂-ICE system (e.g., a pressure sensor in the cylinder, temperature and/or pressure sensors disposed upstream of the cylinder and/or downstream of the cylinder, etc.) during standard operations, emissions calculations during standard operations, or combinations thereof. The injection of lubricant to the cylinder may be controlled via an automation system and/or an indicating system as described previously.

The method of one or more embodiments may include detecting PI events during H₂-ICE conditions via transmission of a signal from one or more sensors of an H₂-ICE engine system, such as a signal transmitted from a pressure sensor located in a cylinder, one or more additional sensors included in the system (e.g., temperature, pressure, emission sensors), or combinations thereof. Each cylinder of the cylinder block may include a pressure sensor in electric connection with a computer of an automation system and/or an indicating system such that each pressure sensor is capable of transmitting local pressure data from each cylinder to the computer. In some embodiments, the amount of lubricant injected may be controlled or adjusted via electronic transmission from the automation system and/or the indicating system based on detected PI events.

The method may include repeating the introducing the lubricant injection to the cylinder during H₂-ICE system operations. In some embodiments, the introduction of lubricant to the cylinder is continuous. In one or more embodiments, the introduction of lubricant to the cylinder is manually controlled. The introduction of lubricant to the cylinder may be automatically controlled via a computer of the automation system and/or indicating system. The automation system may record data from a sensor of the cylinder of the H₂-ICE at a rate of at least 1 Hz, at least 2 Hz, at least 5 Hz, at least 7.5 Hz, at least 10 Hz, or at least 15 Hz. The indicating system may continuously record data from a sensor located in each cylinder for each cycle of the engine.

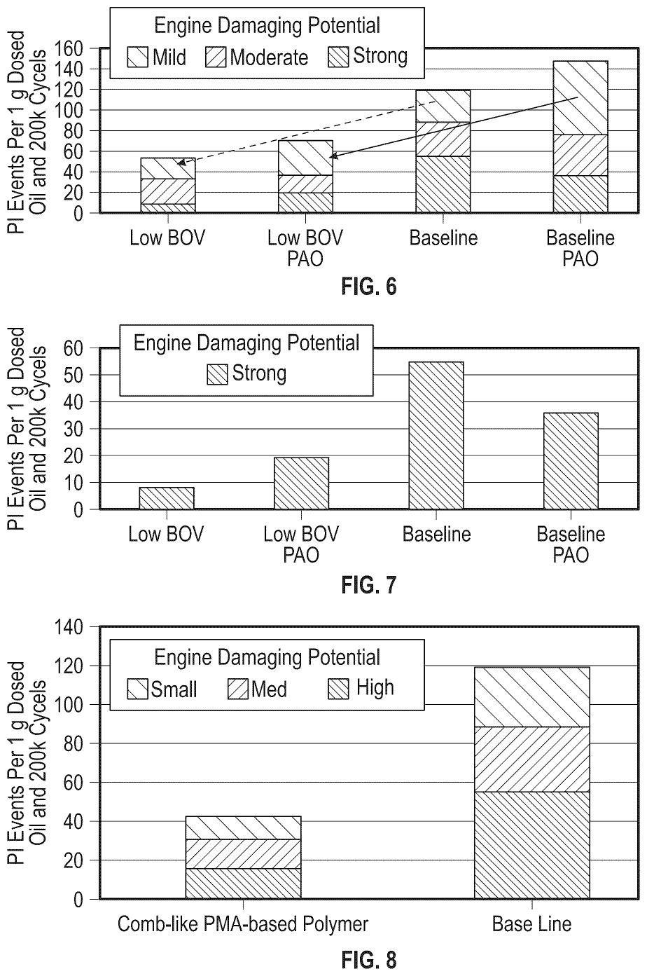

The lubricant composition or a lubricant composition used in a method of one or more embodiments may provide at least 5% improvement in PI events (i.e., reduced frequency and/or damage strength) as compared to a traditional baseline oil or as compared to the same lubricant absent the one or more viscosity modifiers (e.g., a viscosity modifying polymer), the base oil, or a combination thereof. In one or more embodiments, a lubricant may provide at least 10% improvement, at least 20% improvement, at least 30% improvement, at least 50% improvement, at least 75% improvement, or at least 90% improvement in PI events in a H₂-ICE as compared to the same lubricant absent the one or more viscosity modifiers, the base oil, or a combination thereof. For example, the lubricating composition may reduce engine damaging potential of PI events as shown in FIGS. 6 and 7, in which a low viscosity base oil (“Low BOV”) and a Low BOV PAO reduce damaging PI events as compared to baseline lubricating oils (e.g., oils having a KV100 of at least 20 cSt or more, at least 15 cSt or more, at least 12 cSt or more, at least 10 cSt or more, at least 9 cSt or more, at least 8 cSt or more, at least 7 cSt or more, or at least 6 cSt or more). In another example, a PMA-based polymer may reduce PI frequency as compared to a baseline oil as shown in FIG. 8

### ADDITIONAL EMBODIMENTS

In one or more embodiments, the lubricant comprises or results from the admixing of:
i) a base oil comprising a Group I base oil, a Group II base oil, a Group III base oil, a Group IV base oil, or combinations thereof;
ii) viscosity modifier, such as acrylate polymers;
iii) detergent, such as a magnesium containing detergent (such as magnesium salicylate overbased magnesium sulfonate, an overbased magnesium phenate, or combinations thereof); and
iv) the lubricant having a total sulfated ash of less than or equal to 2.0 wt. %, and a SAE viscosity grade of 25W-X, 20W-X, 15W-X, 10W-X, 5W-X or 0W-X, where X represents any one of 8, 12, 16, 20, 30, 40, 50 or 60.

In one or more embodiments, the lubricant including base oil and polymer is derived from a combination of viscosity modifier (polymer) and a diluent that includes less than 50 mass % base oil, and one or more of the following components:
C) one or more detergents;
D) one or more friction modifiers;
E) one or more antioxidants;
F) one or more pour point depressants;
G) one or more anti-foaming agents;
H) one or more dispersants;
I) one or more inhibitors and/or antirust agents; and/or
J) one or more anti-wear agents.

In one or more embodiments, a lubricant including base oil and polymer which is derived from a combination of viscosity modifier (polymer) and a diluent comprising less than 50 mass % base oil, and one or more of the following components:
C) one or more detergents;
D) one or more friction modifiers;
E) one or more antioxidants;
F) one or more pour point depressants;
G) one or more anti-foaming agents;
H) one or more dispersants;
I) one or more inhibitors and/or antirust agents; and/or
J) one or more anti-wear agents.

One or more embodiments herein relate to a lubricant comprising or resulting from the admixing of:
i) a base oil comprising a Group I base oil, a Group II base oil, a Group III base oil, a Group IV base oil, or combinations thereof;
ii) viscosity modifier, such as acrylate polymers; and/or
iii) detergent (such as a magnesium and or calcium containing detergent (such as detergents comprising magnesium and or calcium salicylate, sulfonate, phenate, or combinations thereof).

One or more embodiments presented herein relate to a lubricant for use in a hydrogen fueled internal combustion engine that includes a base oil (such as low viscosity base oil, such as less than 6 cSt (KV100) viscosity base oil), a viscosity modifier at from 0.1 to 4.0 wt. % of the overall lubricant composition comprising an acrylate copolymer, one or more detergents, and/or optionally, phosphorus containing anti-wear agent (such as ZDDP). The lubricant may provides at least 20% improvement in PI events in the hydrogen fueled internal combustion engine compared to the same lubricant absent the viscosity modifier, the low viscosity base oil, or a combination thereof.

One or more embodiments presented herein relate to a concentrate comprising or resulting from the admixing of: from 5 wt. % to less than or equal to 30 wt. % of one or more base oils having a KV100 of less than 6 cSt and comprising a Group I base oil, a Group II base oil, a Group III base oil, a Group IV base oil, or combinations thereof; from 5 to 85 wt. %, based upon the weight of the concentrate, of one or more viscosity modifiers comprising an acrylate copolymer; and from 0 to 50 wt. %, based upon the weight of the concentrate, of one or more metal containing detergents.

In one or more embodiments, the concentrate can further include or result from the combination of the concentrate with a base oil to form a lubricating oil composition that includes:
i) a base oil having a KV100 of less than 6 cSt and included at greater than 50 wt. % of the composition comprising a Group I base oil, a Group II base oil, a Group III base oil, a Group IV base oil, or combinations thereof;
ii) one or more viscosity modifiers at from 0.1 to 4.0 wt. % of the overall lubricant composition comprising an acrylate copolymer; and/or
iii) one or more metal containing detergents.

### EXAMPLES

### Example 1: Test System

Comparative and example lubricating compositions were tested with a test system as shown in FIG. 4. A 12.8 litre, in-line, six-cylinder AVL hydrogen engine was used for Example 1. The present investigations were carried out based on a configuration with external mixture formation (PFI), central position of the spark plug and single-stage turbocharging with variable turbine geometry (VNT). At 1000 rpm, 2200 Nm torque, and between 1600 and 1800 rpm, a power output of slightly below 280 kW can be achieved with the current state of calibration of the system shown in FIG. 4.

### Example 1: Test Method

A test method developed at the Graz University of Technology was used for the comparison of different oil formulations in terms of their tendency for uncontrolled ignition in hydrogen engines.

A small defined quantity of lube oil was introduced as aerosolized drops into the intake area of one individual cylinder using an external dosing system and a dosing lance. The result for each test oil is derived from the number of pre-ignition events at the relevant cylinder during the dosing phase, while the other cylinders act as statistical reference. To minimise any negative cross-influences on the measurement and to ensure high reproducibility and result quality, a one-hour test run was designed and carried out at a steady-state operating point with high combustion stability. The lube oil emission of the engine was calculated based on the carbon balance and as shown in Equation (1).

A diverse range of lubricant formulations was selected for testing, considering different base oils, polymers and additive packages. The rationale behind the selection considers the need to explore the influence of various lubricant properties and formulations on pre-ignition control. Each lubricant sample is characterized by its viscosity and additive composition, providing a basis for evaluating their performance under H₂-ICE conditions.

A commercial API CK-4 oil having key properties given in Table 2 was chosen as base line for this study.

TABLE 2
Main properties of the commercial oil chosen as base line for this study.
Commercial API CK-4 lubricant base line

| | | |
|---|---|---|
| Grade | | 15W-40 |
| KV40° C.* | cSt | 108 |
| KV100° C. | cSt | 14.4 |
| Viscosity | | 137 |
| Index | | |
| Calcium | Parts | 1150 |
| content | per | |
| | million | |
| | (ppm) | |
| Magnesium | ppm | 631 |
| content | | |
| Phosphorus | ppm | 719 |
| content | | |
| Zinc | ppm | 738 |
| content | | |

*Kinematic viscosity at 40° C.

A variety of oils as shown in Table 3 were evaluated to determine the sensitivity of base oils (Base Oil-1 to Base Oil-5), polymer (Polymer-1 and Polymer 2) and additive (Add Pack 1 to Add Pack 3) to pre-ignition (Oil-1 to Oil-5). Polymer-1 used in the formulations of Table 3 is an olefin copolymer Paratone® 24Ex obtained from Chevron. Polymer-2 used in the formulations of Table 3 is a PMA polymer Viscloplex® 3-220 obtained from obtained from Evonik.

TABLE 3
Matrix of the formulations tested in this study: combinations between
the different base oils, polymers and additive packages.

| | Base | | Additive |
|---|---|---|---|
| Candidate | oil | Polymer | technology |
| Base line | 1 | 1 | 1 |
| 1 | 2 | 1 | 1 |
| 2 | 3 | 1 | 1 |
| 3 | 4 | 1 | 1 |
| 4 | [70%] | 1 | 1 |
| | 1 + | | |
| | [30%] | | |
| | 5 | | |
| 5 | 1 | 2 | 1 |

Five different base oils were used in this study: 2 non-synthetics, 2 synthetics, and 1 mixture Group III and Group VI. The main oil's characteristics are listed in Table 4.

TABLE 4
Main characteristics of the base oils used in this study.

| | Base oil 1 | | | | |
|---|---|---|---|---|---|
| | Chevron | Base oil 2 | Base oil 3 | Base oil 4 | Base oil 5 |
| | Neutral Oil | NexBase ™ | Synfluid ® PAO | Synfluid ® PAO | PRIOLUBE ™ |
| Base oil | 220R¹ | 3043² | 4 | 6⁴ | 3970⁵ |
| Group | II | III | IV | IV | V |
| KV 100° C. [cSt] | 6.6 | 4.2 | 4.4 | 6.1 | 4.8 |

¹Chevron Neutral Oil 220R,
²NexBase ™ 3043 obtained from Chevron;
³Synfluid PAO 4,
⁴Synfluid ® PAO 6 obtained from Chevron Phillips Chemical;
⁵PRIOLUBE ™ 3970 obtained from Cargill

The main characteristics of the candidates tested in this study have been summarized in Table 5.

TABLE 5
Main characteristics of the 7 candidates oils characterized
in this study.

| Candidates | | 1 | 2 | 3 | 4 | 5 |
|---|---|---|---|---|---|---|
| Grade | | 5W-40 | 5W-40 | 5W-30 | 15W-40 | 15W-40 |
| KV40° C. | cSt | 89.9 | 90.6 | 79.6 | 110 | 123.8 |
| KV100° C. | cSt | 14.72 | 15.22 | 12.88 | 14.1 | 14.6 |
| Viscosity | | 122 | 124 | 136 | 129 | 105 |
| Index | | | | | | |
| High | cP | 4.04 | 4.03 | 3.7 | 3.85 | 4.05 |
| Temperature | | | | | | |
| High Shear | | | | | | |
| (HTHS) | | | | | | |
| Calcium | ppm | 852 | 818 | 918 | 1046 | 932 |
| Magnesium | ppm | 856 | 820 | 890 | 972 | 847 |
| Phosphorus | ppm | 955 | 953 | 958 | 1084 | 949 |
| Zinc | ppm | 901 | 890 | 927 | 1081 | 931 |

### Example 1: Oil Dosing Test

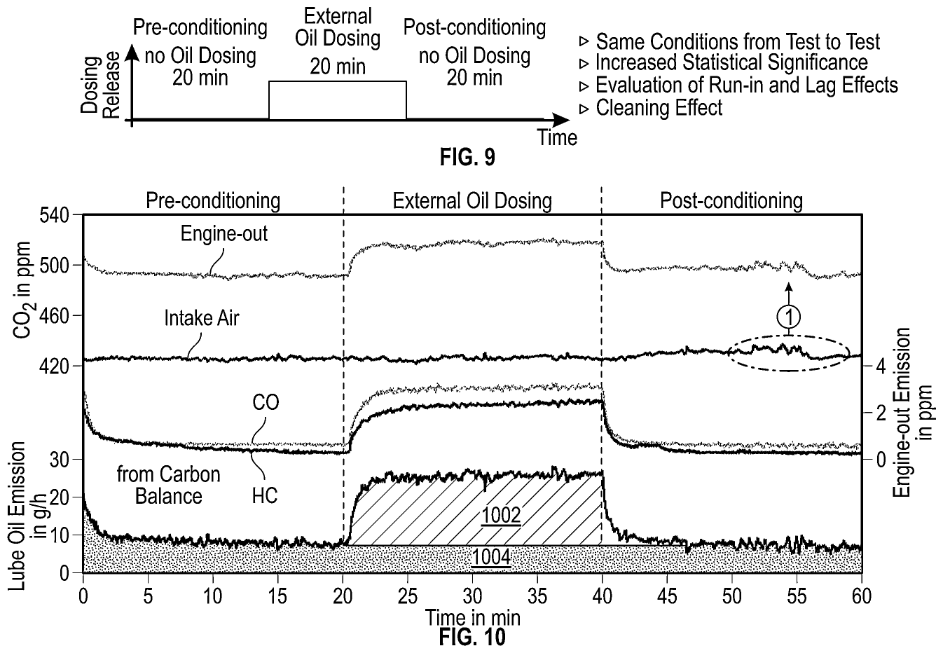

The oil dosing tests were carried out at a steady-state operating point. FIG. 9 shows the one-hour test program based on the dosing release over time. The test program was divided into a 20-minute pre-conditioning phase, a 20-minute oil dosing phase and a final 20-minute post-conditioning phase. The two conditioning phases without external oil dosing increase the robustness of the test methodology. The objectives are the creation of identical test conditions at the time of oil dosing, the avoidance of influences due to accumulated oil from previous tests, the evaluation of run-in and lag effects, the final cleaning (purging) of the engine and the increase of statistical significance due to the high number of cycles with and without external oil dosing. At the end of each test, the external oil dosing unit was cleaned and prepared for the next test. The tests were performed at an operating point of n=1700 rpm (rotations per minute)/Brake mean effective pressure (BMEP)=12 bar.

The average specific oil dosage was set at around 75 milligrams per kilowatt-hours (mg/kWh) (or approximately 0.45 g/kWh related to full-scale engine), which simulates the wear condition of an engine with a long running time. Table 6 summarises the most important test conditions and parameters.

TABLE 6
Main testing conditions and parameters at the analysed
operating point (n = 1700 rpm (rotations per
minute)/Break Mean Effective Pressure (BMEP) = 12 bar)

| | | | |
|---|---|---|---|
| Charge Air | T_{IM} | ° C. | 40 |
| Temperature | | | |
| Coolant | T_{W}_{_{—}}_{Out} | ° C. | 80 |
| Temperature Outlet | | | |
| Exhaust Back | p_{EO} | mbar | 200 |
| Pressure (relative) | | | |
| Air-Fuel Ratio | λ_{EO} | — | 2.35 |
| Ignition Timing | IT | ° CA | −20 |
| Adiabatic | T_{C}_{_{—}}_{Spark} | ° C. | ≈530 |
| Compression | | | |
| Temperature | | | |
| @ Spark | | | |
| Cylinder Peak | Performance | bar | 85 |
| Pressure | Max | | |
| | (PMAX) | | |
| Specific Oil Dosing | \dot{m}_{Oil}_{_{—}}_{spec} | mg/kWh | 75 |
| Quantity | | | |

### Example 1: Data Collection

An automation system coupled to an engine setup as described in FIG. 4, at a frequency of 10 Hz, recorded recording all engine out transient measurement data and the indicating system in electrical connection with the engine setup of FIG. 4 continuously recorded all individual cycles per cylinder.

The external oil dosing process was monitored based on the calculated lube oil emission profile. The lube oil emission, calculated from the carbon-balance (see equation (1)), and the necessary profiles of the measured carbon-containing substances are shown in FIG. 10. The time profiles clearly show how the respective proportions of the substances change in the oil dosing phase and thus how the oil dosing quantity (area 1002) and the lube oil consumption (area 1004) can be explicitly separated from each other.

The need for continuous measurement of the CO₂ content of the fresh air is also illustrated in the diagram by the area marked 1. This demonstrates that the fluctuation of background CO₂ correlates with the change of CO₂ in the exhaust gas and must therefore be measured to accurately determine the oil emission. The comparison between the gravimetrically determined and the calculated oil dosing quantity provides information on possible uncertainties in the dosage, such as leaks or increased wall film formation, or in the emission measurement, and is also checked as an additional quality criterion. To validate the engine boundary conditions, mean values of relevant engine out transient measured variables were calculated for each sub-phase and checked for possible deviations.

### Example 1: Results

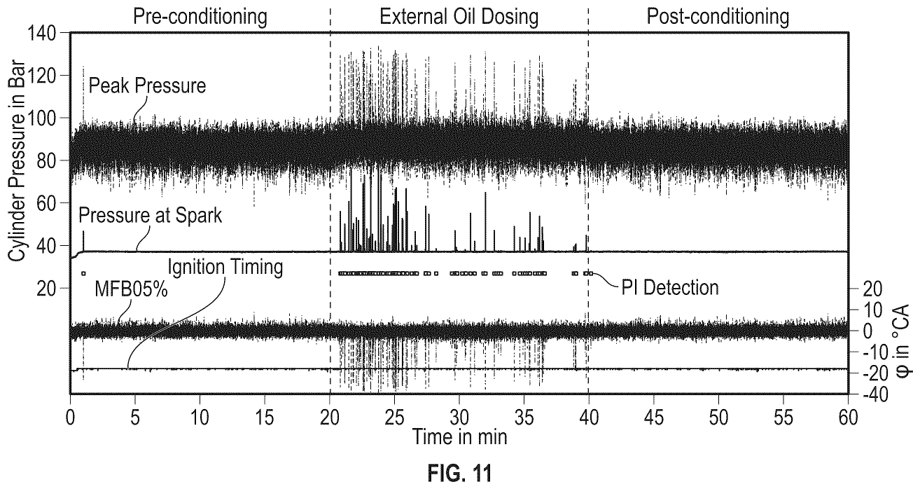

The combustion anomalies were detected and classified depending on various indicating parameters, such as the peak pressure, the mass fraction burned 5% or the knock intensity, and in combination with statistical criteria as the exact start of combustion is not known, which means that a distinction must be made between a normal cyclical fluctuation and abnormal combustion based on relative or absolute threshold values. FIG. 11 illustrates a result evaluation of a continuous indicating measurement (51000 individual cycles) on the dosing cylinder. The diagram shows the peak pressure, the cylinder pressure at spark, the mass fraction burned 5% and the ignition timing. The results demonstrate the correlation between external oil dosing and the associated development of pre-ignition events with a clearly recognisable increase in peak pressures. In phases without oil dosing, only one pre-ignition is recorded at the dosing cylinder.

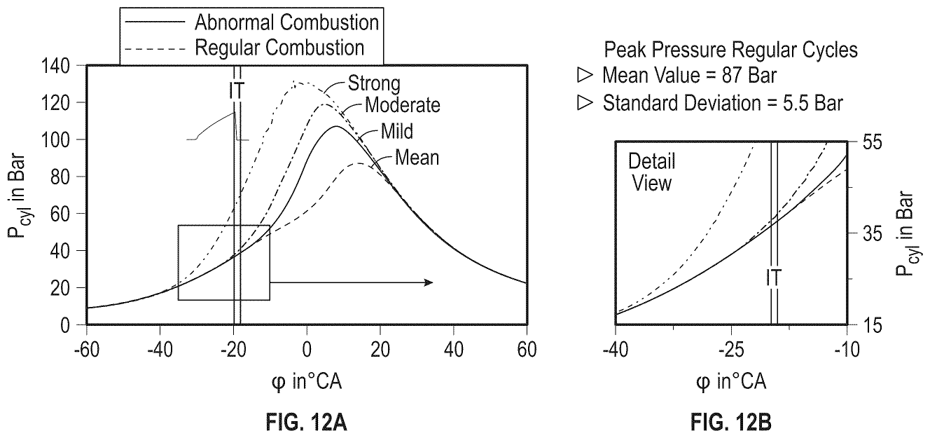

A qualitative categorisation into “stronger”, “moderate” and “milder” pre-ignition events is made depending on the mass fraction burned 5%. This is intended to enable an additional assessment of the damage potential of different test oils. FIGS. 12A and 12B show the crank angle-resolved cylinder pressure traces for regular combustion (mean) and 3 oil-induced pre-ignitions as well as the ignition timing (IT). In the case of the “stronger” pre-ignition, the mass fraction burned 5% is considerably before the regular ignition point, which leads in this example to an increase in peak pressure of up to 50 bar compared to regular combustion. In comparison, the start of combustion for the other two pre-ignitions (“moderate” and “mild” lines) is significantly later and therefore the damage potential for the crank train is at a lower level. Moreover, these very late pre-ignitions (“mild” line) were detected exclusively under the influence of lube oil. One assumption for the late start of combustion is the absence of auto-ignition conditions at an earlier stage in the working cycle. The compression temperature and the evaporation behaviour of the lube oil play a significant role here.

The total number of PI events per cylinder and sub-phase (or specific time segment) represents a partial result. The total number of PIs at the reference cylinder and the PI number at the dosing cylinder during the pre- and post-conditioning phase are further important criteria for the validity of a test. The final evaluation parameter for the externally introduced lube oil is calculated based on the ratio between the number of pre-ignitions during the dosing phase and the calculated oil dosing quantity. The weighting takes slight deviations in the quantity of the externally introduced lube oil between the tests into account. The equation for the weighted PI number based on 200,000 cycles is shown in Equation (2) as follows:

$$\begin{matrix}Weighted PI\_No = \frac{PI\_No \cdot Cycle\_Time}{6 \cdot {m}_{Oil}} & in \frac{1}{g \cdot 200000 cyc}\end{matrix} \qquad ( 2 )$$

$$PI\_No per 20 min ; Cycle\_Time in ms ; {m}_{Oil} in g per 20 min$$

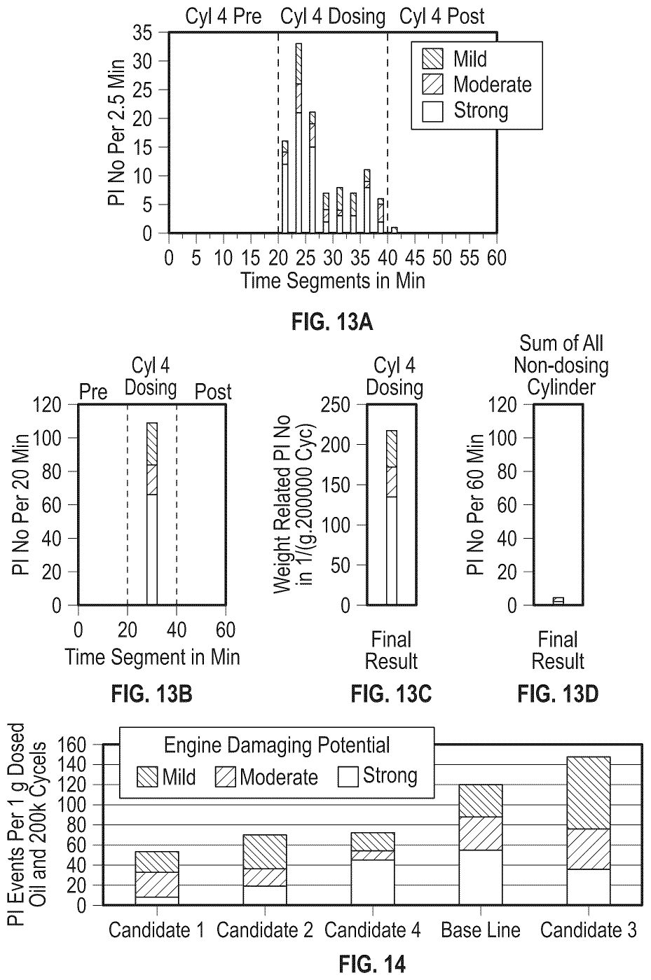

FIGS. 13A, 13B, and 13D show the individual partial results of an oil dosing test and the normalised evaluation parameter of the tested lube oil formulation is shown in FIG. 13C, each with subdivision into the ranges of the damage potential. FIG. 13A represents the temporal rate of the pre-ignition events at the dosing cylinder per 2.5-minute time interval, and FIG. 13B represents the resulting sum per sub-phase. The correlation under the influence of external lube oil dosing is clearly evident. In addition, the reference cylinders (FIG. 13D) also show no significant number of PIs. The selected operating point is therefore stable and has no cross-influence on the result. The reproducibility of the method was confirmed by repeated measurements in different orders using several reference oils with different pre-ignition tendencies.

Based on the test results, it has been shown that the frequency of PI events varies significantly because of base oil type, polymer and the additive technology used to formulate the finished oil.

Experiments considering the variation of base oil used to blend the candidates (as shown in FIG. 14). Results obtained characterizing Candidate 1, 2 and 4 indicate reduced PI sensitivities compared to the baseline. Alternatively, the use of Base Oil 4 to blend Candidate 3 increased the tendency to PI phenomenon when compared to the baseline.

Focusing only on PI events with strong potential damage, it can be noticed that Candidate 1 and Candidate 2 exhibit a lower occurrence of such events, while similar behavior of the baseline has shown by the other two Candidates (Candidates 3 and 4).

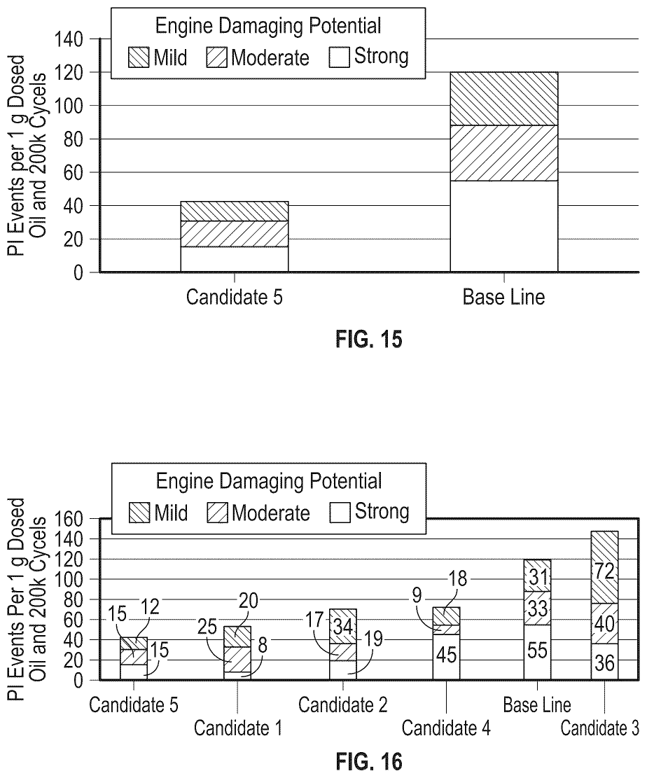

FIG. 15 shows the result of the PI frequency tested with Candidate 5 which has been formulated using a different viscosity modifier than the baseline. Candidate 5 demonstrated a reduction in PI frequency, which indicates that the replacement of polymer 1 with polymer 2 results in a reduction across all three categories of pre-ignition events—mild, moderate, and those with strong potential for engine damage.

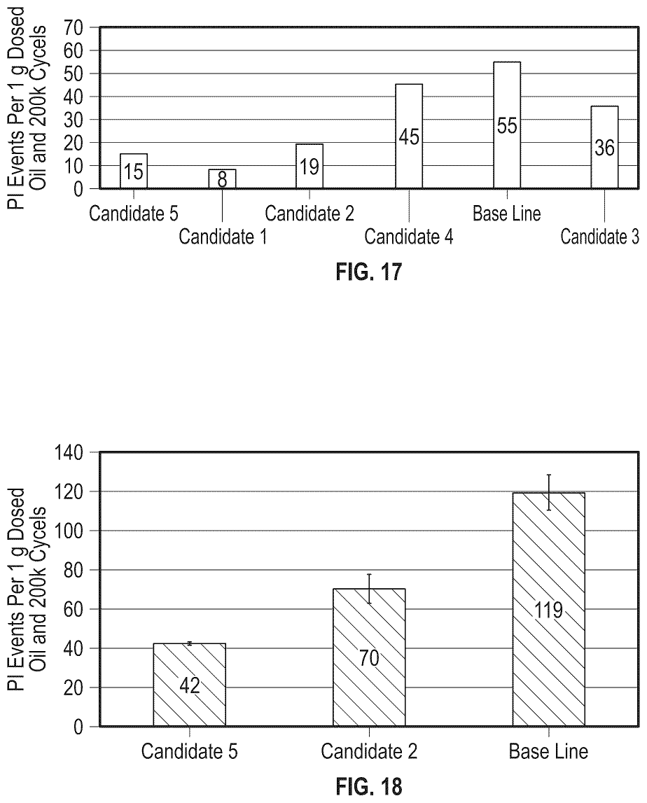

The overall pre-ignition tendency of all the candidates analyzed for this study and the number of events that could cause strong damage to the engine are plotted respectively in FIGS. 17 and 18.

Adopting the right base oil and polymer type can allow for mitigation of strong engine damaging potential events. Though there was no significant influence of additive technology on the total events, the use of the optimized additive package led to a significant reduction in high damaging potential pre-ignition frequency when compared to the baseline reference.

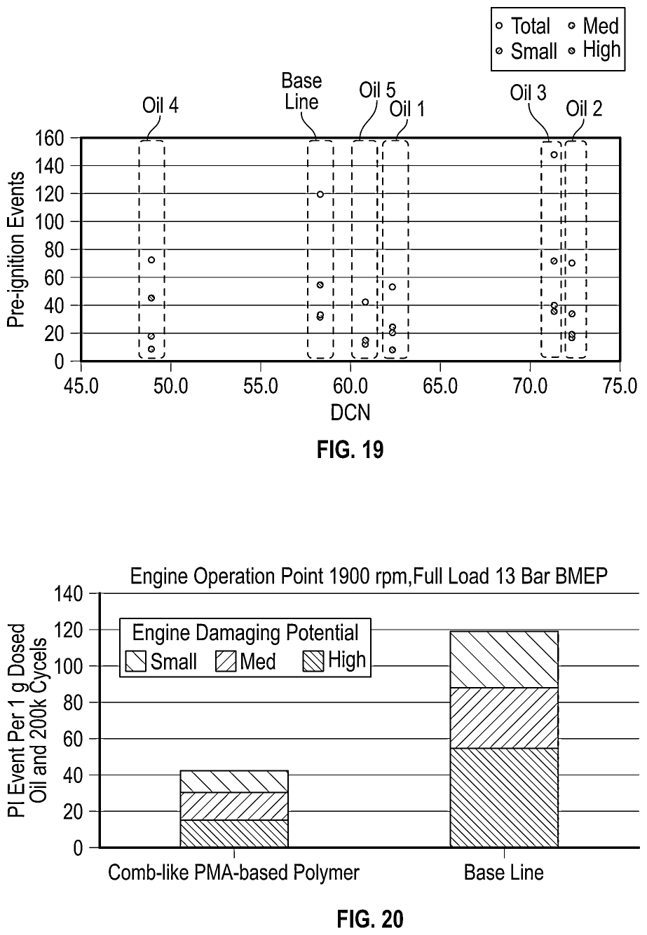

Some of the oils were tested twice, and the outcomes show good repeatability for the pre-ignition test procedure as shown in FIG. 19.

### Example 2

A selected number of oil candidates have been analyzed by means of an Ignition Quality Tester (IQT) to determine their Derived Cetane Number (DCN) according to the ASTM D6890 method. The focus of the investigation was to elucidate the impact of lubricant formulation on the observed DCN measurements, and hence on the potential importance to pre-ignition events.

The findings obtained by IQT are detailed in Table 7 and their graphical representation is illustrated in FIG. 20 against PI events.

TABLE 7
Pre-ignition events obtained on the Candidate 1 to Candidate 5
vs the base line and their DCN value obtained by means of IQT.

| | Pre- | Pre- | Pre- | | |
|---|---|---|---|---|---|
| | ignition | ignition | ignition | | |
| | Small | Medium | High | Total | |
| | engine | engine | engine | Pre- | |
| | damaging | damaging | damaging | ignition | |
| Candidates | potential | potential | potential | events | DCN |
| Base line | 31 | 33 | 55 | 119 | 58.3 |
| 1 | 20 | 25 | 8 | 53 | 62.3 |
| 2 | 34 | 17 | 19 | 70 | 72.3 |
| 3 | 72 | 40 | 36 | 148 | 71.3 |
| 4 | 18 | 9 | 45 | 72 | 48.9 |
| 5 | 12 | 15 | 15 | 42 | 60.8 |

FIG. 20 highlights the absence of a direct correlation between the capability of the lubricants tested in the present work to combust (linked to the ignition delay time, thus the DCN number) and their tendency to show pre-ignition events.

Comparing the pre-ignition characteristics by base oil type from Examples 1 and 2, a reduction in PI events has been obtained using specific base oil types. The impact of polymer is likely to be important to reduce the pre-ignition events. The additive package can be optimized to be used in the H₂-ICE to minimize the likelihood of PIs with strong damaging potential. Compared to the base line, the occurrence of pre-ignition events could be reduced through the utilization of the right polymer (Candidate 5) and/or the right base oil (Candidate 1 and 2).

### Example 3

A comb-like PMA-based polymer (PMA polymer Viscloplex® 3-220 obtained from Evonik) was evaluated for PI frequency and strength and compared to a baseline oil (Chevron Neutral Oil 220R). The same test methods as described in Examples 1 and 2 were performed, with the exception of an engine operating point of 1900 rpm, full load, and a BMEP of 13 bar. Results are shown in FIG. 20, in which the polymer demonstrated a significant reduction in PI strength and frequency as compared to the baseline oil.

Compositions and methods disclosed herein may advantageously reduce PIs in H₂-ICE, both in terms of frequency of occurrence and severity of their impact thereby making an important contribution to the overall robustness of the engine over its intended lifetime. Other major advantages of the methods disclosed herein, when compared to the conventional approach (i.e., endurance tests on a full-scale engine) include shorter testing times required which allow for testing more oil formulations. This enables a focused pre-selection of the oils for further investigations as part of an endurance test or the further optimisation of lube oil formulations based on the knowledge already gained.

Any combinations of the various embodiments and implementations disclosed herein can be used in a further embodiment, consistent with the disclosure.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed:

1. A method for mitigating pre-ignition events in a hydrogen internal combustion engine, the method comprising:
providing a dosing system in fluid communication with a dosing cylinder of a cylinder block of the hydrogen internal combustion engine;
introducing a lubricant comprising a base oil, a polymer, or mixtures thereof to an intake area of the dosing cylinder via the dosing system; and
initiating operating conditions for the hydrogen internal combustion engine.

2. The method of claim 1, wherein:
the base oil has a Kinematic Viscosity value at 100° C. of less than 6 cSt; and
the base oil comprises a Group I base oil, a Group II base oil, a Group III base oil, a Group IV base oil, or combinations thereof.

3. The method of claim 1, wherein the lubricant further comprises one or more selected from detergents, friction modifiers, antioxidants, pour point depressants, anti-foaming agents, dispersants, inhibitors and/or antirust agents, and anti-wear agents.

4. The method of claim 1, wherein the lubricant is obtained from mixing the base oil with a concentrate comprising a viscosity modifying polymer and a diluent.

5. The method of claim 1, wherein:
the polymer is a comb-like polymethyl acrylate-based polymer, and
the polymer is present in the form of a concentrate.

6. The method of claim 1, wherein:
the lubricant has a total sulfated ash of less than or equal to 2.0 wt. %, and/or
the lubricant has a SAE viscosity grade of 25W-X, 20W-X, 15W-X, 10W-X, 5W-X or 0W-X, where X represents any one of 8, 12, 16, 20, 30, 40, 50 or 60.

7. The method of claim 1, wherein:
the dosing system comprises a dosing lance located upstream of an ignition timing area of the intake area, and/or
each cylinder of the cylinder block comprises a pressure sensor to detect abnormal combustion.

8. The method of claim 7 wherein the dosing lance is located downstream of hydrogen injection valves that are proximate to the dosing cylinder.

9. A method for detecting preignition of a lubricant in a hydrogen internal combustion engine, the method comprising:
introducing a lubricant comprising a base oil, a polymer, or mixtures thereof upstream of an ignition timing area of a dosing cylinder of the engine;
initiating preignition conditions for the engine; and
detecting preignition events in the engine.

10. The method of claim 9, wherein the base oil comprises one or more selected from the group consisting of one or more polyalphaolefins and mineral oil, and/or wherein the polymer is a comb-like polymethyl acrylate-based polymer.

11. The method of claim 9, wherein the hydrogen internal combustion engine is in electric connection with an automation system, an indicating system, or both.

12. The method of claim 11, wherein the automation system records data from a sensor of the dosing cylinder of the hydrogen internal combustion engine at a rate of 10 Hertz (Hz), and wherein the indicating system continuously records data from a sensor located in each cylinder for each cycle of the engine.

13. The method of claim 9, wherein the detecting the preignition events comprises:
collecting, by a first computer, data from a pressure sensor of an oil dosing cylinder of a cylinder block of the hydrogen internal combustion engine;
collecting, by a second computer, continuous measurements from a sensor located in each cylinder for each cycle of the engine; and
postprocessing the collected data and measurements to detect the pre-ignition events.

14. The method of claim 13, wherein the data collected by the first computer is processed to calculate an oil dosing quantity.

15. The method of claim 13, wherein the data collected by the first computer comprises pressure measurements of the dosing cylinder.

16. The method of claim 13, wherein the data collected by the second computer comprises continuous pressure measurements from each cylinder in the engine block.

17. The method of claim 13, wherein the postprocessing further comprises:
performing method validation and statistical evaluation; and
calculating oil dosing quantity based on a carbon balance of the engine.

18. An internal combustion engine lubricant comprising:
a base oil having a KV100 of at least 6 cSt or less, and/or
from 0.001 mass % to 16.0 mass % of a polymer based on the total weight of the lubricant.

19. The lubricant of claim 18, further comprising one or more selected from detergents, friction modifiers, antioxidants, pour point depressants, anti-foaming agents, dispersants, inhibitors and/or antirust agents, and anti-wear agents

20. The lubricant of claim 18, wherein:
the base oil comprises a Group I base oil, a Group II base oil, a Group III base oil, a Group IV base oil, or combinations thereof,
the polymer is present in the form of a concentrate.
the lubricant has a total sulfated ash of less than or equal to 2.0 wt. %, and/or
the lubricant has a SAE viscosity grade of 25W-X, 20W-X, 15W-X, 10W-X, 5W-X or 0W-X, where X represents any one of 8, 12, 16, 20, 30, 40, 50 or 60.
